(19) United States
(12) Patent Application Publication
(10) Pub. No.: US 2015/0363724 A1
(43) Pub. Date: Dec. 17, 2015

(54) REUSABLE ANONYMOUS SUBSCRIPTION

(71) Applicant: Oracle International Corporation, Redwood Shores, CA (US)

(72) Inventors: Ramkrishna Chatterjee, Nashua, NH (US); Gopalan Arun, Saratoga, CA (US); Ramesh Vasudevan, Los Altos, CA (US)

(21) Appl. No.: 14/624,364

(22) Filed: Feb. 17, 2015

Related U.S. Application Data
(60) Provisional application No. 62/010,617, filed on Jun. 11, 2014.

(51) Int. Cl. G06Q 10/06; G06Q 30/00

(52) U.S. Cl. CPC G06Q 10/06313; G06Q 30/016

(57) ABSTRACT

Anonymous reuse of cloud services in a computer network cloud infrastructure system is described. Cloud services can include infrastructure as a service (IAAS) storage and processing services, platform as a service (PAAS) database and Java services, and software as a service (SAAS) customer relationship management services. Upon subscribing to a cloud system, services can be configured from an existing pool of pre-provisioned services. When a service is to be decommissioned, its resources are returned back to the pool for reuse thereby minimizing the time to provision new resources as well as maximizing resource usage.

### CROSS-REFERENCES TO RELATED APPLICATIONS

The present application is related to the following applications, the entire contents of which are incorporated herein by reference for all purposes:

(1) U.S. Provisional Application No. 61/698,413, filed Sep. 7, 2012, entitled “Tenant Automation System;”
(2) U.S. Provisional Application No. 61/698,459, filed Sep. 7, 2012, entitled “Service Development Infrastructure;”
(3) U.S. Provisional Application No. 61/785,299, filed Mar. 14, 2013, entitled “Cloud Infrastructure;”
(4) U.S. Provisional Application No. 61/794,427, filed Mar. 15, 2013, entitled “Cloud Infrastructure;” and
(5) U.S. Provisional Application No. 61/799,461, filed Mar. 15, 2013, entitled “Service Association Model.”

The present application hereby incorporates by reference in its entirety for all purposes U.S. Provisional Application No. 61/698,463, filed Sep. 7, 2012, entitled “Shared Identity Management Architecture.”

The present application claims priority and benefit from U.S. Provisional Application No. 62/010,617, filed Jun. 11, 2014, entitled “REUSABLE ANONYMOUS SUBSCRIPTION.”

The entire contents of the above-identified non-provisional and provisional patent applications are incorporated herein by reference for all purposes.

### BACKGROUND

The present disclosure relates to computer systems and software, and more particularly to techniques for facilitating and automating the provision of services in a cloud environment.

Cloud computing is a model for enabling convenient, on-demand network access to a shared pool of configurable computing resources (e.g., networks, servers, storage, applications, and services). The services provided or accessed through the cloud (or network) are referred to as cloud services. There is a lot of processing that needs to be performed by a cloud service provider to make cloud services available to a subscribing customer. Due to its complexity, much of this processing is still done manually. For example, provisioning resources for providing such cloud services can be a very labor intensive process.

Consumers and businesses have an expectation that ordering and starting the use of computer network cloud-based services be seamless. However, many cloud services are difficult to start up, requiring the provisioning of resources that might be shared. For example, servers in a server farm may run cloud services for many customers at once, and adding another customer may require shifting around resources. Different users may wish to employ different services. For example, some users may only want raw storage on the cloud, while other users may want to use sophisticated database storage. Still others may want the use of graphical user interface (GUI) software applications running on the cloud for its employees or customers.

Some businesses try a cloud-based service to determine whether it fits their needs. However, a business may be reluctant to test a service because the process for establishing a regular subscription to that service may involve configuring additional or new resources before access to the service can be enabled by the subscription. The configuring of additional or new resources may delay or interrupt the business's use of the service. Further, customer data created during testing of the service may not be retained for subsequent use of the service under a regular subscription. Businesses may be burdened to expend time and money to implement an environment used while testing the service to regenerate the customer data for subsequent use based on the regular subscription. These challenges may not afford some businesses the flexibility to try a service before purchasing a subscription for the service. Providers of cloud-services may lose opportunities to gain additional customers who are unwilling try a service before subscribing to the service. The providers may be burdened with the task of re-provisioning resources for a service each time a different business wishes to try the service. Customers and service providers stand to benefit from techniques to reduce time for provisioning of resources to enable services and to retain customer data related to use of those services.

There exists a need in the art for faster, less expensive, and easier-to-use cloud based computer systems.

### SUMMARY

Generally, aspects of the present disclosure relate to techniques for providing a user with access to a service that has already been provisioned by a cloud infrastructure system. Examples of types of services include, without limitation, Software as a Service (SaaS) category, Platform as a Service (PaaS) category, Infrastructure as a Service (IaaS) category, or other categories of services including hybrid services. The provisioned services may be reused for different users to reduce the time for provisioning a service each time that service is requested by a different user.

A cloud infrastructure system may implement techniques to enable services provisioned by the cloud infrastructure system to be reused anonymously by different users. The system may configure a subscription, called a “reusable anonymous subscription” (RAS), which may provide a user access to a service provided by the system before obtaining a regular subscription for the service. A service accessible by the RAS may already be provisioned. The cloud infrastructure system may configure one or more pools of RASs, each RAS providing a reusable subscription to a pre-provisioned service. Upon a request by a user for a service, a RAS for the service may be assigned from the pool to the user to access the service.

When a user decides not to convert a RAS to a regular subscription, the RAS is returned to the pool for reuse of the service provisioned for that RAS. The service provisioned for the RAS will remain provisioned when the RAS is returned to the pool, thereby minimizing the time to provision new resources for the service as well as maximizing resource usage. The RAS may be reassigned to another user if a previous user does not convert the RAS to a regular subscription.

When a user decides to convert a RAS to a regular subscription, the RAS may not be returned to a pool. The RAS may be converted to a regular subscription using a light-weight conversion process. Since the service provided by the RAS is already provisioned, the conversion process may be light-weight such that the service does not need to be provisioned again. The conversion process may establish an account that is assigned a regular subscription for use of the service already provisioned for the RAS.

In some embodiments, customer-specific data generated during use of a service provided by a RAS may be separated from service-specific data related to the service. When a RAS is returned to a pool, the service-specific data for the service provided by the RAS may be maintained in association with the RAS, while the customer-specific data may be disassociated with the RAS. The RAS may be reassigned to another user after the RAS is returned to the pool and the customer-specific data has been disassociated with the RAS. When the RAS is converted to a regular subscription, the customer-specific data may be retained and associated with the regular subscription. As such, the user provided with the regular subscription may continue use of the service with the existing customer-specific data created during use of the service through a RAS.

At least one embodiment, techniques are disclosed for providing a user with access to a service that has already been provisioned by a cloud infrastructure system. One technique is a method that can be implemented by a computing system. The computing system can be included in a service infrastructure system. The service infrastructure system may be implemented by a cloud infrastructure system. The service infrastructure system may include a multi-tenant environment. The method may include providing multiple services in a service infrastructure system. The services may include a Java® service, a customer relationship management (CRM) service, or a human capital management (HCM) service. Each service of the services may be associated with service-specific data. The method may include receiving a request by a first customer to access a first service in the multiple services. The method may include determining that the first service has been provisioned for a first subscription in a service pool by the service infrastructure system. In some embodiments, the method may include provisioning the first service for the first subscription in the service pool upon determining that the first service has not been provisioned for a subscription in the service pool. The method may include assigning the first subscription for the first service from the service pool to the first customer. Assigning the first subscription to the first customer may include removing the first subscription from the service pool. The method may include associating customer-specific data corresponding to the first customer with service-specific data corresponding to the first service. The customer-specific data may be associated with the first customer for the first service. The method may include assigning the first subscription from the first customer to the service pool. Assigning the first subscription may include removing an association between the customer-specific data and the service-specific data corresponding to the first service. The first subscription may be reassignable from the service pool to one or more additional customers.

In some embodiments, providing the services includes provisioning one or more of the services in the cloud infrastructure system prior to receiving the request by the first customer. A service may be provisioned based on one or more metrics related to operation of the service infrastructure system. A service may be provisioned based on one or more metrics associated with demand for the service. A service may be provisioned based on one or more metrics associated with the type of the service.

In some embodiments, service-specific data corresponding to a service indicates a configuration for the service. The configuration includes one or more resources allocated to provide the service.

In some embodiments, the customer-specific data associated with the first customer includes data related to use of the first service by the customer.

In some embodiments, the method may further include receiving a request by the second customer to access a second service in the multiple services. The method may include determining that the second service is available in the service pool based on determining that the second service is similar to the first service. The method may include assigning the first subscription in the service pool to the second customer. Assigning the first subscription to the second customer may include removing the first subscription from the service pool. The method may include associating customer-specific data corresponding to the second customer with service-specific data corresponding to the first service.

In some embodiments, a service pool includes a plurality of subscriptions. Each of the plurality of subscriptions may be associated with at least one service provided by the service infrastructure system.

Yet other embodiments relate to systems and machine-readable tangible storage media that employ or store instructions and/or code to perform operations to implement the techniques described herein.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The following detailed description together with the accompanying drawings will provide a better understanding of the nature and advantages of the present invention.

### BRIEF DESCRIPTION OF THE DRAWINGS

Illustrative embodiments of the present invention are described in detail below with reference to the following drawing figures:

FIG. 1A is a logical view of a cloud infrastructure system according to one embodiment of the present invention.

FIG. 1B is a simplified block diagram of a hardware/software stack that may be used to implement a cloud infrastructure system according to an embodiment of the present invention.

FIG. 2 is a simplified block diagram of a system environment for implementing the cloud infrastructure system shown in FIG. 1A.

FIG. 3A depicts a simplified flowchart 300 depicting processing that may be performed by the TAS module in the cloud infrastructure system, in accordance with an embodiment of the present invention.

FIG. 3B depicts a simplified high level diagram of one or more sub-modules in the TAS module in the cloud infrastructure system, in accordance with an embodiment of the present invention.

FIG. 4 depicts an exemplary distributed deployment of the TAS component, according to an embodiment of the present invention.

FIG. 5 is a simplified block diagram illustrating the interactions of the SDI module with one or more modules in the cloud infrastructure system, in accordance with an embodiment of the present invention.

FIG. 6 depicts a simplified high level diagram of sub-modules of the SDI module according to an embodiment of the present invention.

FIG. 7A depicts a simplified flowchart depicting processing that may be performed by the SDI component in the cloud infrastructure system, in accordance with an embodiment of the present invention.

FIG. 7B depicts a simplified block diagram showing the high-level architecture of a Nuviaq system 710 and its relationships with other cloud infrastructure components according to an embodiment of the present invention.

FIG. 7C depicts an example sequence diagram illustrating steps of a provisioning process using a Nuviaq system according to an embodiment of the present invention.

FIG. 7D depicts an example sequence diagram illustrating steps of a deployment process using a Nuviaq system according to an embodiment of the present invention.

FIG. 7E depicts an example of database instances provisioned for a database service according to an embodiment of the present invention.

FIG. 8A depicts a simplified block diagram of a system environment for providing reusable anonymous subscriptions according to some embodiments of the present invention.

FIG. 8B depicts an example of data structures for implementing reusable anonymous subscriptions according to some embodiments of the present invention.

FIG. 8C is a flowchart of a process for managing the lifecycle of a reusable anonymous subscription according to various embodiments.

FIG. 9 illustrates a high level overview of the various interactions involved to provide a tenant environment, in accordance with an embodiment of the present invention.

FIG. 10 depicts a simplified diagram of a distributed system for implementing an embodiment.

FIG. 11 illustrates an exemplary computer system that may be used to implement an embodiment of the present invention.

### DETAILED DESCRIPTION

In the following description, for the purposes of explanation, specific details are set forth in order to provide a thorough understanding of embodiments of the invention. However, it will be apparent that various embodiments may be practiced without these specific details. The figures and description are not intended to be restrictive.

Certain embodiments of the present invention provide techniques for automating the provisioning, managing and tracking of services provided by a cloud infrastructure system.

### Introduction

In certain embodiments, a cloud infrastructure system may include a suite of applications, middleware and database service offerings that are delivered to a customer in a self-service, subscription-based, elastically scalable, reliable, highly available, and secure manner. An example of such a cloud infrastructure system is the Oracle Public Cloud provided by the present assignee.

A cloud infrastructure system may provide many capabilities including, but not limited to, provisioning, managing and tracking a customer's subscription for services and resources in the cloud infrastructure system, providing predictable operating expenses to customers utilizing the services in the cloud infrastructure system, providing robust identity domain separation and protection of a customer's data in the cloud infrastructure system, providing customers with a transparent architecture and control of the design of the cloud infrastructure system, providing customers assured data protection and compliance with data privacy standards and regulations, providing customers with an integrated development experience for building and deploying services in the cloud infrastructure system and providing customers with a seamless integration between business software, middleware, database and infrastructure services in the cloud infrastructure system.

In certain embodiments, services provided by the cloud infrastructure system may include a host of services that are made available to users of the cloud infrastructure system on demand such as online data storage and backup solutions, Web-based e-mail services, hosted office suites and document collaboration services, database processing, managed technical support services and the like. Services provided by the cloud infrastructure system can dynamically scale to meet the needs of its users. A specific instantiation of a service provided by cloud infrastructure system is referred to herein as a service instance. In general, any service made available to a user via a communication network such as the Internet from a cloud service provider's system is referred to as a cloud service. Typically, in a public cloud environment, servers and systems that make up the cloud service provider's system are different from the customer's own on-premises servers and systems. For example, a cloud service provider's system may host an application and a user may, via a communication network such as the Internet, on demand, order and use the application.

A service in a computer network cloud infrastructure includes protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and script-language middleware engine for private use by a networked developer. As another example, a service can include access to an email software application hosted on a cloud vendor's web site.

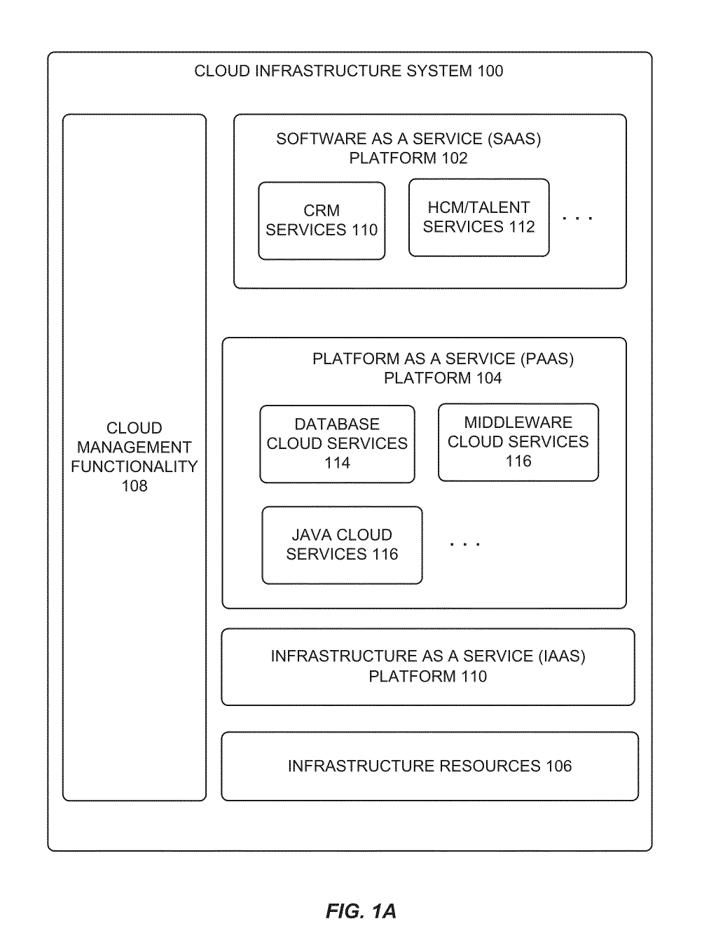

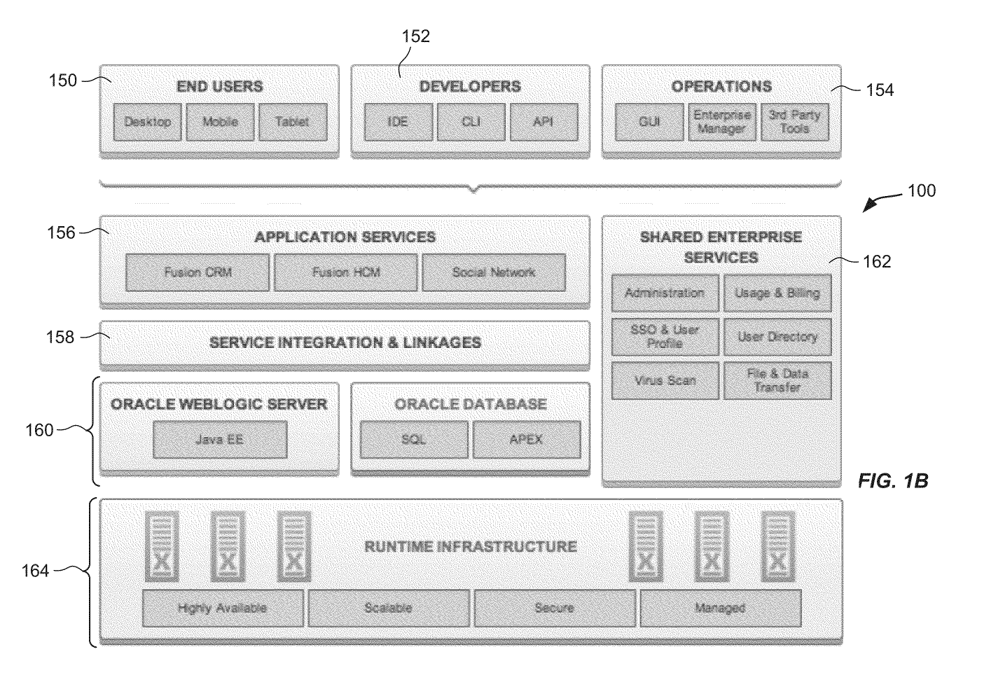

FIG. 1A is a logical view of a cloud infrastructure system according to one embodiment of the present invention. Cloud infrastructure system 100 may provide a variety of services via a cloud or networked environment. These services may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 100. Cloud infrastructure system 100 then performs processing to provide the services in the customer's subscription order.

Cloud infrastructure system 100 may provide the cloud services via different deployment models. For example, services may be provided under a public cloud model where cloud infrastructure system 100 is owned by an organization selling cloud services (e.g., owned by Oracle) and the services are made available to the general public or different industry enterprises. As another example, services may be provided under a private cloud model where cloud infrastructure system 100 is operated solely for a single organization and may provide services for one or more entities within the organization. The cloud services may also be provided under a community cloud model where cloud infrastructure system 100 and the services provided by system 100 are shared by several organizations in a related community. The cloud services may also be provided under a hybrid cloud model, which is a combination of two or more different models.

As shown in FIG. 1A, cloud infrastructure system 100 may comprise multiple components, which working in conjunction, enable provision of services provided by cloud infrastructure system 100. In the embodiment illustrated in FIG. 1A, cloud infrastructure system 100 includes a SaaS platform 102, a PaaS platform 104, an IaaS platform 110, infrastructure resources 106, and cloud management functionality 108. These components may be implemented in hardware, or software, or combinations thereof.

SaaS platform 102 is configured to provide cloud services that fall under the SaaS category. For example, SaaS platform 102 may provide capabilities to build and deliver a suite of on-demand applications on an integrated development and deployment platform. SaaS platform 102 may manage and control the underlying software and infrastructure for providing the SaaS services. By utilizing the services provided by SaaS platform 102, customers can utilize applications executing on cloud infrastructure system 100. Customers can acquire the application services without the need for customers to purchase separate licenses and support.

Various different SaaS services may be provided. Examples include without limitation services that provide solutions for sales performance management, enterprise integration and business flexibility for large organizations, and the like. In one embodiment, the SaaS services may include Customer Relationship Management (CRM) services 110 (e.g., Fusion CRM services provided by the Oracle cloud), Human Capital Management (HCM)/Talent Management services 112, and the like. CRM services 110 may include services directed to reporting and management of a sales activity cycle to a customer, and others. HCM/Talent services 112 may include services directed to providing global workforce lifecycle management and talent management services to a customer.

Various different PaaS services may be provided by PaaS platform 104 in a standardized, shared and elastically scalable application development and deployment platform. Examples of PaaS services may include without limitation services that enable organizations (such as Oracle) to consolidate existing applications on a shared, common architecture, as well as the ability to build new applications that leverage the shared services provided by the platform. PaaS platform 104 may manage and control the underlying software and infrastructure for providing the PaaS services. Customers can acquire the PaaS services provided by cloud infrastructure system 100 without the need for customers to purchase separate licenses and support. Examples of PaaS services include without limitation Oracle Java Cloud Service (JCS), Oracle Database Cloud Service (DBCS), and others.

By utilizing the services provided by PaaS platform 104, customers can utilize programming languages and tools supported by cloud infrastructure system 100 and also control the deployed services. In some embodiments, PaaS services provided by the cloud infrastructure system 100 may include database cloud services 114, middleware cloud services (e.g., Oracle Fusion Middleware services) 116 and Java cloud services 117. In one embodiment, database cloud services 114 may support shared service deployment models that enable organizations to pool database resources and offer customers a database-as-a-service in the form of a database cloud, middleware cloud services 116 provides a platform for customers to develop and deploy various business applications and Java cloud services 117 provides a platform for customers to deploy Java applications, in the cloud infrastructure system 100. The components in SaaS platform 102 and PaaS platform 104 illustrated in FIG. 1A are meant for illustrative purposes only and are not intended to limit the scope of embodiments of the present invention. In alternate embodiments, SaaS platform 102 and PaaS platform 104 may include additional components for providing additional services to the customers of cloud infrastructure system 100.

Various different IaaS services may be provided by IaaS platform 110. The IaaS services facilitate the management and control of the underlying computing resources such as storage, networks, and other fundamental computing resources for customers utilizing services provided by the SaaS platform and the PaaS platform.

In certain embodiments, cloud infrastructure system 100 includes infrastructure resources 106 for providing the resources used to provide various services to customers of the cloud infrastructure system 100. In one embodiment, infrastructure resources 106 includes pre-integrated and optimized combinations of hardware such as servers, storage and networking resources to execute the services provided by the PaaS platform and the SaaS platform.

In certain embodiments, cloud management functionality 108 provides comprehensive management of cloud services (e.g., SaaS, PaaS, IaaS services) in the cloud infrastructure system 100. In one embodiment, cloud management functionality 108 includes capabilities for provisioning, managing and tracking a customer's subscription received by the cloud infrastructure system 100, and the like.

FIG. 1B is a simplified block diagram of a hardware/software stack that may be used to implement cloud infrastructure system 100 according to an embodiment of the present invention. It should be appreciated that implementation depicted in FIG. 1B may have other components than those depicted in FIG. 1B. Further, the embodiment shown in FIG. 1B is only one example of a cloud infrastructure system that may incorporate an embodiment of the invention. In some other embodiments, cloud infrastructure system 100 may have more or fewer components than shown in FIG. 1B, may combine two or more components, or may have a different configuration or arrangement of components. In certain embodiments, the hardware and software components are stacked so as to provide vertical integration that provides optimal performance.

Various types of users may interact with cloud infrastructure system 100. These users may include, for example, end users 150 that can interact with cloud infrastructure system 100 using various client devices such as desktops, mobile devices, tablets, and the like. The users may also include developers/programmers 152 who may interact with cloud infrastructure system 100 using command line interfaces (CLIs), application programming interfaces (APIs), through various integrated development environments (IDEs), and via other applications. User may also include operations personnel 154. These may include personnel of the cloud service provider or personnel of other users.

Application services layer 156 identifies various cloud services that may be offered by cloud infrastructure system 100. These services may be mapped to or associated with respective software components 160 (e.g., Oracle WebLogic server for providing Java services, oracle database for providing database services, and the like) via a service integration and linkages layer 158.

In certain embodiments, a number of internal services 162 may be provided that are shared by different components or modules of cloud infrastructure system 100 and by the services provided by cloud infrastructure system 100. These internal shared services may include, without limitation, a security and identity service, an integration service, an enterprise repository service, an enterprise manager service, a virus scanning and white list service, a high availability, backup and recovery service, service for enabling cloud support in IDEs, an email service, a notification service, a file transfer service, and the like.

Runtime infrastructure layer 164 represents the hardware layer on which the various other layers and components are built. In certain embodiments, runtime infrastructure layer 164 may comprise one Oracle's Exadata machines for providing storage, processing, and networking resources. An Exadata machine may be composed of various database servers, storage Servers, networking resources, and other components for hosting cloud-services related software layers. In certain embodiments, the Exadata machines may be designed to work with Oracle Exalogic, which is an engineered system providing an assemblage of storage, compute, network, and software resources. The combination of Exadata and Exalogic provides a complete hardware and software engineered solution that delivers high-performance, highly available, scalable, secure, and a managed platform for providing cloud services.

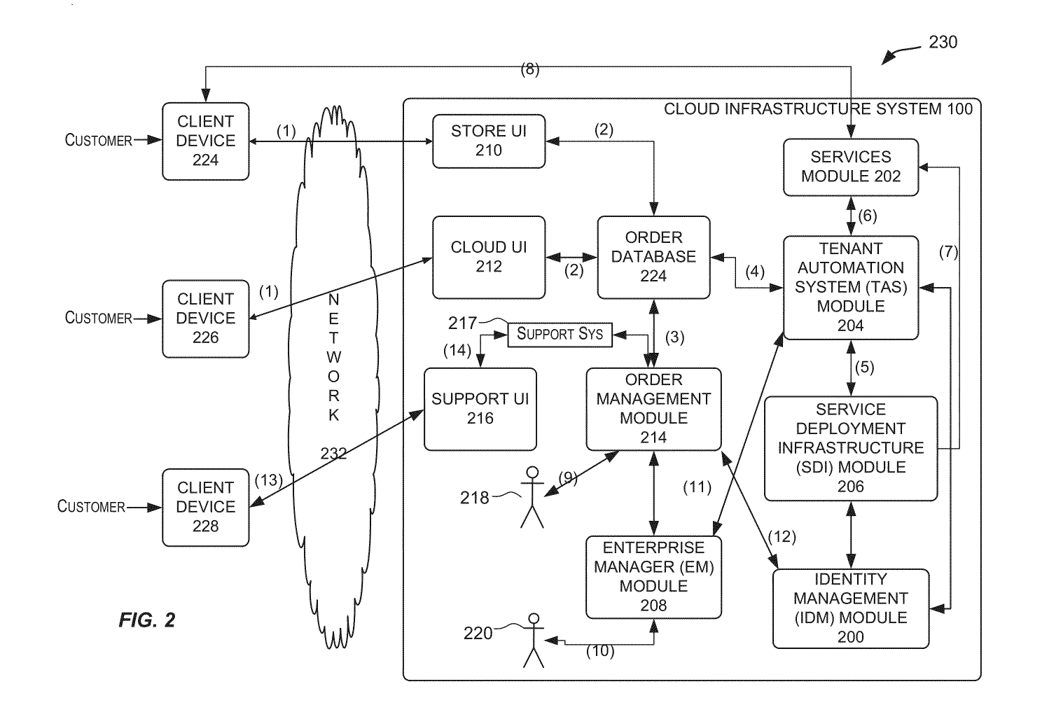

FIG. 2 is a simplified block diagram of a system environment for implementing the cloud infrastructure system shown in FIG. 1A according to an embodiment of the present invention. In the illustrated embodiment, system environment 230 includes one or more client computing devices 224, 226 and 228 that may be used by users to interact with cloud infrastructure system 100. A client device may be configured to operate a client application such as a web browser, a proprietary client application (e.g., Oracle Forms), or some other application, which may be used by a user of the client device to interact with cloud infrastructure system 100 to utilize services provided by cloud infrastructure system 100.

It should be appreciated that cloud infrastructure system 100 depicted in FIG. 2 may have other components than those depicted in FIG. 2. Further, the embodiment shown in FIG. 2 is only one example of a cloud infrastructure system that may incorporate an embodiment of the invention. In some other embodiments, cloud infrastructure system 100 may have more or fewer components than shown in FIG. 2, may combine two or more components, or may have a different configuration or arrangement of components.

Client computing devices 224, 226 and 228 may be general purpose personal computers (including, by way of example, personal computers and/or laptop computers running various versions of Microsoft Windows and/or Apple Macintosh operating systems), cell phones or PDAs (running software such as Microsoft Windows Mobile and being Internet, e-mail, SMS, Blackberry, or other communication protocol enabled), workstation computers running any of a variety of commercially-available UNIX or UNIX-like operating systems (including without limitation the variety of GNU/Linux operating systems), or any other computing device. For example, client computing devices 224, 226 and 228 may be any other electronic device, such as a thin-client computer, Internet-enabled gaming system, and/or personal messaging device, capable of communicating over a network (e.g., network 232 described below). Although exemplary system environment 230 is shown with three client computing devices, any number of client computing devices may be supported. Other devices such as devices with sensors, etc. may interact with cloud infrastructure system 100.

A network 232 may facilitate communications and exchange of data between clients 224, 226 and 228 and cloud infrastructure system 100. Network 232 may be any type of network familiar to those skilled in the art that can support data communications using any of a variety of commercially-available protocols, including without limitation TCP/IP, SNA, IPX, AppleTalk, and the like. Merely by way of example, network 232 can be a local area network (LAN) such as an Ethernet network, a Token-Ring network and/or the like, a wide-area network, a virtual network, including without limitation a virtual private network (VPN), the Internet, an intranet, an extranet, a public switched telephone network (PSTN), an infra-red network, a wireless network (e.g., a network operating under any of the IEEE 802.1X suite of protocols, the Bluetooth protocol known in the art, and/or any other wireless protocol), and/or any combination of these and/or other networks.

Cloud infrastructure system 100 may comprise one or more computers and/or servers which may be general purpose computers, specialized server computers (including, by way of example, PC servers, UNIX servers, mid-range servers, mainframe computers, rack-mounted servers, etc.), server farms, server clusters, or any other appropriate arrangement and/or combination. The computing devices that make up cloud infrastructure system 100 may run any of operating systems or a variety of additional server applications and/or mid-tier applications, including HTTP servers, FTP servers, CGI servers, Java servers, database servers, and the like. Exemplary database servers include without limitation those commercially available from Oracle, Microsoft, Sybase, IBM and the like.

In various embodiments, cloud infrastructure system 100 may be adapted to automatically provision, manage and track a customer's subscription to services offered by cloud infrastructure system 100. In one embodiment, as depicted in FIG. 2, the components in cloud infrastructure system 100 include an Identity Management (IDM) module 200, a services module 202, a Tenant Automation System (TAS) module 204, a Service Deployment Infrastructure (SDI) module 206, an Enterprise Manager (EM) module 208, one or more front-end web interfaces such as a store user interface (UI) 210, a cloud user interface (UI) 212, and a support user interface (UI) 216, an order management module 214, sales personnel 218, operator personnel 220 and an order database 224. These modules may include or be provided using one or more computers and/or servers which may be general purpose computers, specialized server computers, server farms, server clusters, or any other appropriate arrangement and/or combination. In one embodiment, one or more of these modules can be provided by cloud management functionality 108 or IaaS platform 110 in cloud infrastructure system 100. The various modules of the cloud infrastructure system 100 depicted in FIG. 2 are meant for illustrative purposes only and are not intended to limit the scope of embodiments of the present invention. Alternative embodiments may include more or fewer modules than those shown in FIG. 2.

In an exemplary operation, at (1) a customer using a client device such as client device 224 or 226 may interact with cloud infrastructure system 100 by browsing the various services provided by cloud infrastructure system 100 and placing an order for a subscription for one or more services offered by cloud infrastructure system 100. In certain embodiments, the customer may access store UI 210 or cloud UI 212 and place a subscription order via these user interfaces.

The order information received by cloud infrastructure system 100 in response to the customer placing an order may include information identifying the customer and one or more services offered by the cloud infrastructure system 100 that the customer intends to subscribe to. A single order may include orders for multiple services. For instance, a customer may login to cloud UI 212 and request a subscription for a CRM service and a Java cloud service in the same order.

Additionally, the order may also include one or more service levels for the ordered services. As used herein, and as will be discussed in greater detail below, a service level for a service determines the amount of resources to be allocated for providing the requested service in the context of the subscription, such as the amount of storage, amount of computing resources, data transfer facilities, and the like. For example, a basic service level may provide a minimum level of storage, data transmission, or number of users, and higher service levels may include additional resources.

In addition, in some instances, the order information received by cloud infrastructure system 100 may include information indicative of a customer level, and the time period during which the service is desired. The customer level specifies the priority of the customer making the subscription request. In one example, the priority may be determined based on the quality of service that the cloud infrastructure system 100 guarantees or promises the customer as specified by a Service Level Agreement (SLA) agreed to between the customer and the provider of the cloud services. In one example, the different customer levels include a basic level, a silver level and a gold level. The time period for a service may specify the start date and time for the service and the time period for which the service is desired (e.g., a service end date and time may be specified).

In one embodiment, a customer may request a new subscription via store UI 210 or request for a trial subscription via cloud UI 212. In certain embodiments, store UI 210 may represent the service provider's eCommerce store front (e.g., www.oracle.com/store for Oracle Cloud services). Cloud UI 212 may represent a business interface for the service provider. Consumer can explore available services and sign up for interested services through cloud UI 212. Cloud UI 212 captures user input necessary for ordering trial subscriptions provided by cloud infrastructure system 100. Cloud UI 212 may also be used to view account features and configure the runtime environment located within cloud infrastructure system 100. In addition to placing an order for a new subscription, store UI 210 may also enable the customer to perform other subscription-related tasks such as changing the service level of a subscription, extending the term of the subscription, increasing the service level of a subscription, terminating an existing subscription, and the like.

After an order has been placed per (1), at (2), the order information that is received via either store UI 210 or cloud UI 212 is stored in order database 224, which can be one of several databases operated by cloud infrastructure system 100 and utilized in conjunction with other system elements. While order database 224 is shown logically as a single database in FIG. 2, in actual implementation, this may comprise one or more databases.

At (3), the order is forwarded to order management module 214. Order management module 214 is configured to perform billing and accounting functions related to the order such as verifying the order and upon verification, booking the order. In certain embodiments, order management module 214 may include a contract management module and an install base module. The contract management module may store contract information associated with the customer's subscription order such as the customer's service level agreement (SLA) with cloud infrastructure system 100. The install base module may include detailed descriptions of the services in the customer's subscription order. In addition to order information, the install base module may track installation details related to the services, product status and support service history related to the services. As a customer orders new services or upgrades existing ones, the install base module may automatically add new order information.

At (4), information regarding the order is communicated to TAS module 204. In one embodiment, TAS module 204 utilizes the order information to orchestrate the provisioning of services and resources for the order placed by the customer. At (5), TAS component 204 orchestrates the provisioning of resources to support the subscribed services using the services of SDI module 206. At (6) TAS module 204 provides information related to the provisioned order received from SDI module 206 to services module 202. In some embodiments, at (7), SDI module 206 may also use services provided by services module 202 to allocate and configure the resources needed to fulfill the customer's subscription order.

At (8), services module 202 sends a notification to the customers on client devices 224, 226 and 228 regarding the status of the order.

In certain embodiments, TAS module 204 functions as an orchestration component that manages business processes associated with each order and applies business logic to determine whether an order should proceed to provisioning. In one embodiment, upon receiving an order for a new subscription, TAS module 204 sends a request to SDI module 206 to allocate resources and configure those resources needed to fulfill the subscription order. SDI module 206 enables the allocation of resources for the services ordered by the customer. SDI module 206 provides a level of abstraction between the cloud services provided by cloud infrastructure system 100 and the physical implementation layer that is used to provision the resources for providing the requested services. TAS module 204 may thus be isolated from implementation details such as whether or not services and resources are actually provisioned on the fly or pre-provisioned and only allocated/assigned upon request.

In certain embodiments, a user may use store UI 210 to directly interact with order management module 214 to perform billing and accounting related functions such as verifying the order and upon verification, booking the order. In some embodiments, instead of a customer placing an order, at (9), the order may instead be placed by sales personnel 218 on behalf of the customer such as a customer's service representative or sales representative. Sales personnel 218 may directly interact with order management module 214 via a user interface (not shown in FIG. 2) provided by order management module 214 for placing orders or for providing quotes for the customer. This, for example, may be done for large customers where the order may be placed by the customer's sales representative through order management module 214. The sales representative may set up the subscription on behalf of the customer.

EM module 208 is configured to monitor activities related to managing and tracking a customer's subscription in cloud infrastructure system 100. EM module 208 collects usage statistics for the services in the subscription order such as the amount of storage used, the amount data transferred, the number of users, and the amount of system up time and system down time. At (10), a host operator personnel 220, who may be an employee of a provider of cloud infrastructure system 100, may interact with EM module 208 via an enterprise manager user interface (not shown in FIG. 2) to manage systems and resources on which services are provisioned within cloud infrastructure system 100.

Identity management (IDM) module 200 is configured to provide identity services such as access management and authorization services in cloud infrastructure system 100. In one embodiment, IDM module 200 controls information about customers who wish to utilize the services provided by cloud infrastructure system 100. Such information can include information that authenticates the identities of such customers and information that describes which actions those customers are authorized to perform relative to various system resources (e.g., files, directories, applications, communication ports, memory segments, etc.) IDM module 200 can also include the management of descriptive information about each customer and about how and by whom that descriptive information can be accessed and modified.

In one embodiment, information managed by the identity management module 200 can be partitioned to create separate identity domains. Information belonging to a particular identity domain can be isolated from all other identity domains. Also, an identity domain can be shared by multiple separate tenants. Each such tenant can be a customer subscribing to services in the cloud infrastructure system 100. In some embodiments, a customer can have one or many identity domains, and each identity domain may be associated with one or more subscriptions, each subscription having one or many services. For example, a single customer can represent a large entity and identity domains may be created for divisions/departments within this large entity. EM module 208 and IDM module 200 may in turn interact with order management module 214 at (11) and (12) respectively to manage and track the customer's subscriptions in cloud infrastructure system 100.

In one embodiment, at (13), support services may also be provided to the customer via a support UI 216. In one embodiment, support UI 216 enables support personnel to interact with order management module 214 via a support backend system to perform support services at (14). Support personnel in the cloud infrastructure system 100 as well as customers can submit bug reports and check the status of these reports via support UI 216.

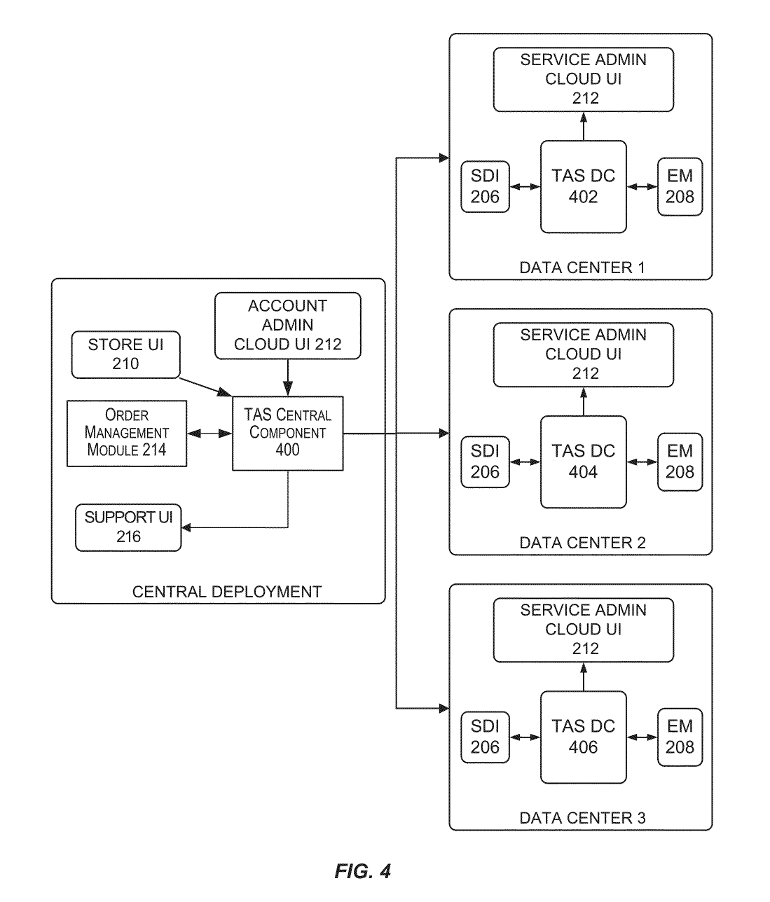

Other interfaces, not shown in FIG. 2 may also be provided by cloud infrastructure system 100. For example, an identity domain administrator may use a user interface to IDM module 200 to configure domain and user identities. In addition, customers may log into a separate interface for each service they wish to utilize. In certain embodiments, a customer who wishes to subscribe to one or more services offered by cloud infrastructure system 100 may also be assigned various roles and responsibilities. In one embodiment, the different roles and responsibilities that may be assigned for a customer may include that of a buyer, an account administrator, a service administrator, an identity domain administrator or a user who utilizes the services and resources offered by cloud infrastructure system 100. The different roles and responsibilities are described more fully in FIG. 4 below.

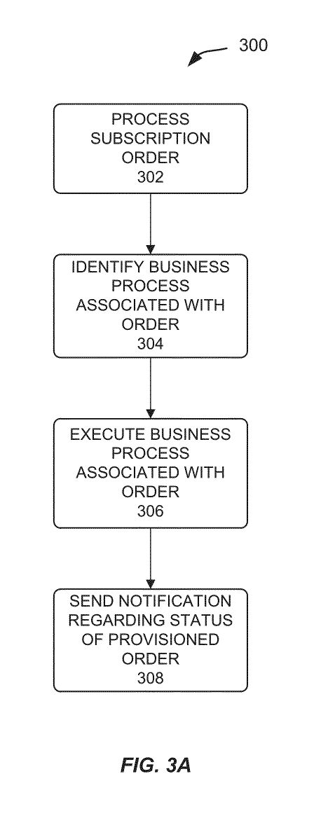

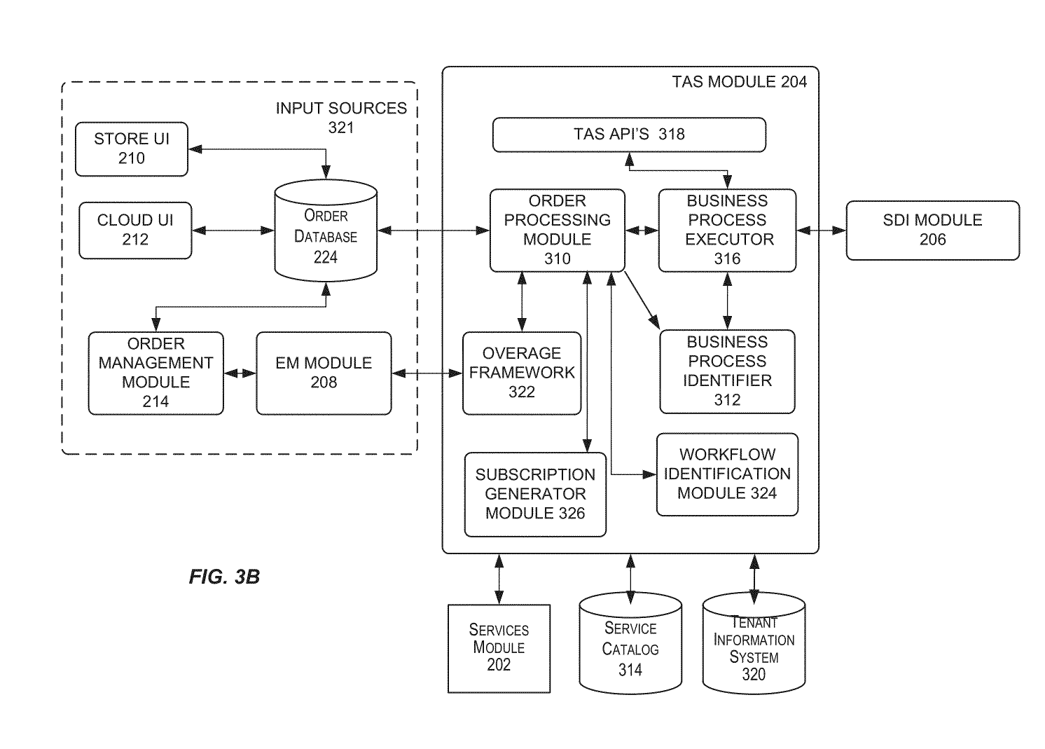

FIG. 3A depicts a simplified flowchart 300 depicting processing that may be performed by the TAS module in the cloud infrastructure system, in accordance with an embodiment of the present invention. The processing depicted in FIG. 3A may be implemented in software (e.g., code, instructions, program) executed by one or more processors, hardware, or combinations thereof. The software may be stored in memory (e.g., on a memory device, on a non-transitory computer-readable storage medium). The particular series of processing steps depicted in FIG. 3A is not intended to be limiting. Other sequences of steps may also be performed according to alternative embodiments. For example, alternative embodiments of the present invention may perform the steps outlined above in a different order. Moreover, the individual steps illustrated in FIG. 3A may include multiple sub-steps that may be performed in various sequences as appropriate to the individual step. Furthermore, additional steps may be added or removed depending on the particular applications. One of ordinary skill in the art would recognize many variations, modifications, and alternatives. In one embodiment, the processing depicted in FIG. 3A may be performed by one or more components in TAS component 204 as will be described in detail in FIG. 3B.

At 302, a customer's subscription order is processed. The processing may include validating the order, in one example. Validating the order includes ensuring that the customer has paid for the subscription and ensuring that the customer does not already have subscriptions with the same name or that the customer is not attempting to create multiple subscriptions of the same type in the same identity domain for subscription types for which this is disallowed (such as, in the case of a CRM service). Processing may also include tracking the status of an order for each order that is being processed by cloud infrastructure system 100.

At 304, a business process associated with the order is identified. In some instances, multiple business processes may be identified for an order. Each business process identifies a series of steps for processing various aspects of the order. As an example, a first business process may identify one or more steps related to provisioning physical resources for the order, a second business process may identify one or more steps related to creating an identity domain along with customer identities for the order, a third business process may identify one or more steps for related to performing back office functions such as creating a customer record for the user, performing accounting functions related to the order, and the like. In certain embodiments, different business processes may also be identified for processing different services in an order. For example, different business process may be identified to process a CRM service and a database service.

At 306, the business process identified for the order in 304 is executed. Executing the business process associated with the order may include orchestrating the series of steps associated with the business process identified in step 304. For example, executing a business process related to provisioning physical resources for the order may include sending a request to SDI module 206 to allocate resources and configure those resources needed to fulfill the subscription order.

At 308, a notification is sent to the customer regarding the status of the provisioned order. Additional description related to performing steps 302, 304, 306 and 308 is provided in detail in FIG. 3B.

FIG. 3B depicts a simplified high level diagram of one or more sub-modules in the TAS module in the cloud infrastructure system, in accordance with an embodiment of the present invention. In one embodiment, the modules depicted in FIG. 3B perform the processing described in steps 302-308 discussed in FIG. 3A. In the illustrated embodiment, TAS module 204 comprises an order processing module 310, a business process identifier 312, a business process executor 316, an overage framework 322, a workflow identification module 324, and a bundled subscription generator module 326. These modules may be implemented in hardware, or software, or combinations thereof. The various modules of the TAS module depicted in FIG. 3B are meant for illustrative purposes only and are not intended to limit the scope of embodiments of the present invention. Alternative embodiments may include more or fewer modules than those shown in FIG. 3B.

In one embodiment, order processing module 310 receives an order from a customer from one or more input sources 321. For example, order processing module 310 may directly receive an order via cloud UI 212 or store UI 210, in one embodiment. Alternatively, order processing module 310 may receive an order from order management module 214 or order database 224. Order processing module 310 then processes the order. In certain embodiments, processing the order includes generating a customer record which includes information about the order such as a service type, a service level, a customer level, the type of resources, the amount of the resources to be allocated to the service instance and a time period during which the service is desired. As part of the processing, order processing module 310 also determines whether the order is a valid order. This includes ensuring that the customer does not already have subscriptions with the same name or that the customer is not attempting to create multiple subscriptions of the same type in the same identity domain for subscription types where this is disallowed (such as, in the case of a fusion CRM service).

Order processing module 310 may also perform additional processing on the order. Processing may include tracking the status of an order for each order that is being processed by cloud infrastructure system 100. In one embodiment, order processing module 310 may process each order to identify a number of states pertaining to the order. In one example, the different states of an order may be an initialized state, a provisioned state, an active state, an administration required state, an error state, and the like. An initialized state refers to the state of a new order; a provisioned state refers to the state of an order once the services and resources for the order have been provisioned. An order is in an active state when the order has been processed by TAS module 204 and a notification to that effect has been delivered to the customer. An order is in an administration required state when intervention by an administrator is needed to resolve the issue. The order is in an error state when the order cannot be processed. In addition to maintaining the order progress status, order processing module 310 also maintains detailed information about any failures encountered during process execution. In other embodiments, and as will be discussed in detail below, the additional processing performed by order processing module 310 may also include changing the service level for a service in the subscription, changing the services included in the subscription, extending the time period of the subscription, and canceling the subscription or specifying different service levels for different time periods in the subscription.

After an order has been processed by order processing module 310, business logic is applied to determine whether the order should proceed to provisioning. In one embodiment, as part of orchestrating the order, business process identifier 312 receives the processed order from order processing module 310 and applies business logic to identify a particular business process to use for the order being processed. In one embodiment, business process identifier 312 may utilize information stored in a service catalog 314 to determine the particular business process to be used for the order. In one embodiment, and as discussed in FIG. 3A, multiple business processes may be identified for an order and each business process identifies a series of steps for processing various aspects of the order. In another embodiment, and as discussed above, different business processes may be defined for different types of services, or combinations of services such as a CRM service or a database service. In one embodiment, service catalog 314 may store information mapping an order to a particular type of business process. Business process identifier 312 may use this information to identify a specific business process for the order being processed.

Once a business process has been identified, business process identifier 312 communicates the particular business process to be executed to business process executor 316. Business process executor 316 then executes steps of the identified business process by operating in conjunction with one or more modules in the cloud infrastructure system 100. In some embodiments, business process executor 316 acts as an orchestrator for performing the steps associated with a business process. For example, the business process executor may interact with order processing module 310 to execute steps in a business process that identifies workflows related to the order, determines the overage of services in the order or identifies service components related to the order.

In one example, business process executor 316 interacts with SDI module 206 to execute steps in a business process for allocating and provisioning resources for services requested in the subscription order. In this example, for each step in the business process, business process executor 316 may send a request to SDI component 206 to allocate resources and configure resources needed to fulfill the particular step. SDI component 206 is responsible for the actual allocation of the resources. Once all the steps of the business processes of an order have been executed, business process executor 316 may send a notification to the customer of the processed order by utilizing the services of services component 202. The notification may include sending an email notification to the customer with details of the processed order. The email notification may also include deployment information related to the order to enable the customer to access the subscribed services.

In certain embodiments, TAS module 204 may provide one or more TAS Application Programming Interfaces (APIs) 318 that enable TAS module 204 to interact with other modules in cloud infrastructure system 100 and for other modules to interact with TAS module 204. For example, the TAS APIs may include a system provisioning API that interacts with SDI module 206 via an asynchronous Simple Object Access Protocol (SOAP) based web services call to provision resources for the customer's subscription order. In one embodiment, TAS module 204 may also utilize the system provisioning API to accomplish system and service instance creation and deletion, switch a service instance to an increased service level, and associate service instances. An example of this is the association of a Java service instance to a fusion applications service instance to allow secure web service communications. The TAS APIs may also include a notification API that interacts with the services module 202 to notify the customer of a processed order. In certain embodiments, the TAS module 204 also periodically propagates subscription information, outages, and notifications (e.g. planned downtime) to services component 202.

In certain embodiments, TAS module 204 periodically receives usage statistics for each of the provisioned services such as the amount of storage used, the amount data transferred, the number of users, and the amount of system up time and system down time from EM module 208. Overage framework 322 utilizes the usage statistics to determine whether over use of a service has occurred, and if so, to determine how much to bill for the overage, and provides this information to order management module 214.

In certain embodiments, TAS module 204 includes an order workflow identification module 324 that is configured to identify one or more workflows associated with processing a customer's subscription order. In certain embodiments, TAS module 204 may include a subscription order generation framework 326 for generating subscription orders for a customer when the customer places a subscription order for one or more services offered by the cloud infrastructure system 100. In one embodiment, a subscription order includes one or more service components responsible for providing the services requested by a customer in the subscription order.

Additionally, TAS module 204 may also interact with one or more additional databases such as a Tenant Information System (TIS) database 320 to enable the provisioning of resources for one or more services subscribed by the customer while taking into consideration historical information, if any, available for the customer. TIS database 320 may include historical order information and historical usage information pertaining to orders subscribed by the customer.

TAS module 204 may be deployed using different deployment models. In certain embodiments, the deployment includes a central component that interfaces with one or more distributed components. The distributed components may, for example, be deployed as various data centers and accordingly may also be referred to as data center components. The central component includes capabilities to process orders and co-ordinate services in cloud infrastructure system 100, while the data center components provide capabilities for provisioning and operating the runtime system that provides the resources for the subscribed services.

FIG. 4 depicts an exemplary distributed deployment of the TAS module, according to an embodiment of the present invention. In the embodiment depicted in FIG. 4, the distributed deployment of TAS module 204 includes a TAS central component 400 and one or more TAS Data Centers (DCs) components 402, 404 and 406. These components may be implemented in hardware, or software, or combinations thereof.

In one embodiment, the responsibilities of TAS central component 400 include, without limitation, to provide a centralized component for receiving customer orders, performing order-related business operations such as creating a new subscription, changing the service level for a service in the subscription, changing the services included in the subscription, and extending the time period of the subscription, or canceling the subscription. The responsibilities of TAS central component 400 may also include maintaining and serving subscription data needed by cloud infrastructure system 100 and interfacing with order management module 214, support UI 216, cloud UI 212 and store UI 210 to handle all the back-office interactions.

In one embodiment, the responsibilities of TAS DCs 402, 404 and 406 include, without limitation, performing runtime operations for orchestrating the provisioning the resources for one or more services subscribed by the customer. TAS DCs 402, 404 and 406 also include capabilities to perform operations such as locking, unlocking, enabling, or disabling a subscription order, collecting metrics related to the order, determining the status of the order, and sending notification events related to the order.

In an exemplary operation of the distributed TAS system shown in FIG. 4, TAS central component 400 initially receives an order from a customer via cloud UI 212, store UI 210, via order management system 214, or via order database 224. In one embodiment, the customer represents a buyer who has financial information and the authority to order and/or change a subscription. In one embodiment, the order information includes information identifying the customer, the type of services that the customer wishes to subscribe to, and an account administrator who will be responsible for handling the request. In certain embodiments, the account administrator may be nominated by the customer when the customer places an order for a subscription to one or more services offered by cloud infrastructure system 100. Based on the order information, the TAS central component 400 identifies the data region of the world such as Americas, EMEA, or Asia Pacific in which the order originates and the particular TAS DCs (for e.g., 402, 404 or 406) that will be deployed for provisioning the order. In one embodiment, the particular TAS DC (for e.g., from among DCs 402, 404 or 406) that will be deployed for provisioning the order is determined based on the geographical data region in which the request originated.

TAS central component 400 then sends the order request to the particular TAS DC in which to provision services for the order request. In one embodiment, TAS DCs 402, 404 or 406 identify a service administrator and an identity domain administrator responsible for processing the order request at the particular TAS DC. The service administrator and the identity administrator may be nominated by the account administrator identified in the subscription order. TAS DCs 402, 404 or 406 communicate with SDI module 204 to orchestrate the provisioning of physical resources for the order. SDI component 204 in respective TAS DCs 402, 404 or 406 allocates resources and configures those resources needed to fulfill the subscription order.

In certain embodiments, TAS DCs, 402, 404 or 406 identify an identity domain associated with the subscription. SDI component 206 may provide the identity domain information to IDM component 200 (shown in FIG. 2) for identifying an existing identity domain or creating a new identity domain. Once the order is provisioned by the SDI module at respective TAS DCs, 402, 404 or 406, TAS central component 400 may place information regarding the provisioned resources in a support system, via support UI 216. Information may include, for example, displaying resource metrics related to the services and usage statistics of the services.

Once in operation, at each data center, EM module 208 to periodically collects usage statistics for each of the provisioned services provisioned at that data center, such as the amount of storage used, the amount data transferred, the number of users, and the amount of system up time and system down time. These statistics are provided to the TAS DC that is local to EM module 208 (i.e., at the same data center). In an embodiment, the TAS DCs may use the usage statistics to determine whether overuse of a service has occurred, and if so, to determine how much to bill for the overage, and provide the billing information to order management system 214.

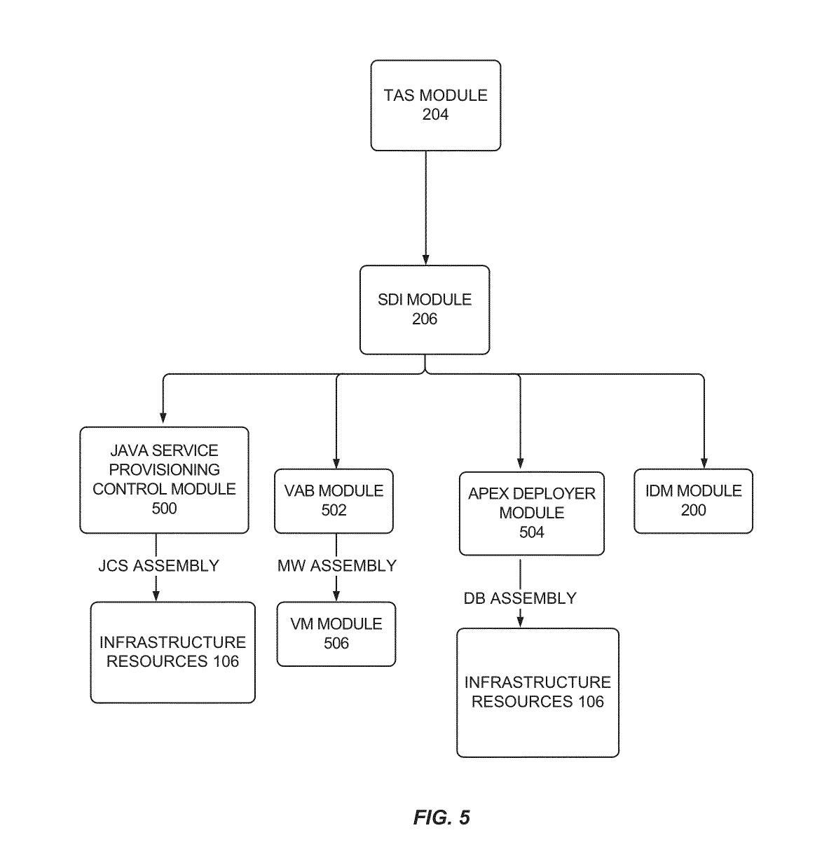

FIG. 5 is a simplified block diagram illustrating the interactions of the SDI module with one or more modules in the cloud infrastructure system, in accordance with an embodiment of the present invention. In one embodiment, SDI module 206 interacts with TAS module 204 to provision resources for services in a subscription order received by TAS module 204. In certain embodiments, one or more of the modules illustrated in FIG. 5 may be modules within cloud infrastructure system 100. In other embodiments, one or more of the modules that interact with SDI module 206 may be outside cloud infrastructure system 100. In addition, alternative embodiments may have more or less modules than those shown in FIG. 5. These modules may be implemented in hardware, or software, or combinations thereof.

In one embodiment, the modules in SDI module 206 may include one or more modules in SaaS platform 102 and PaaS platform 104 in cloud infrastructure system 100. In order to perform provisioning of resources for various services, SDI module 206 may interact with various other modules, each customized to help with provisioning resources for a particular type of service. For example, as illustrated in FIG. 5, SDI module 206 may interact with a Java service provisioning control module 500 to provision Java cloud services. In one embodiment, Java service provisioning control component 500 may deploy a Java Cloud Service (JCS) assembly specified by SDI module 206 that includes a set of tasks to be performed to provision Java cloud services. Infrastructure resources 106 then determines the resources needed to provision the Java cloud services.

As other examples, SDI module 206 may interact with one or more modules such as a Virtual Assembly Builder (VAB) module 502, an Application Express (APEX) deployer module 504, a Virtual Machine (VM) module 506, an IDM module 200, and a database machine module 118. VAB module 502 includes capabilities to configure and provision complete multi-tier application environments. In one embodiment, VAB module 502 deploys a Middleware (MW) service assembly specified by SDI module 206 to provision a MW service in cloud infrastructure system 100 using the services provided by VM module 506. APEX deployer module 504 includes capabilities to configure and provision database services. In one embodiment, APEX deployer module 504 deploys a database service assembly specified by SDI module 206 to provision a database service in cloud infrastructure system 100 using the resources provided by infrastructure resources 106. SDI module 206 interacts with IDM module 200 to provide identity services such as access management across multiple applications in cloud infrastructure system 100.

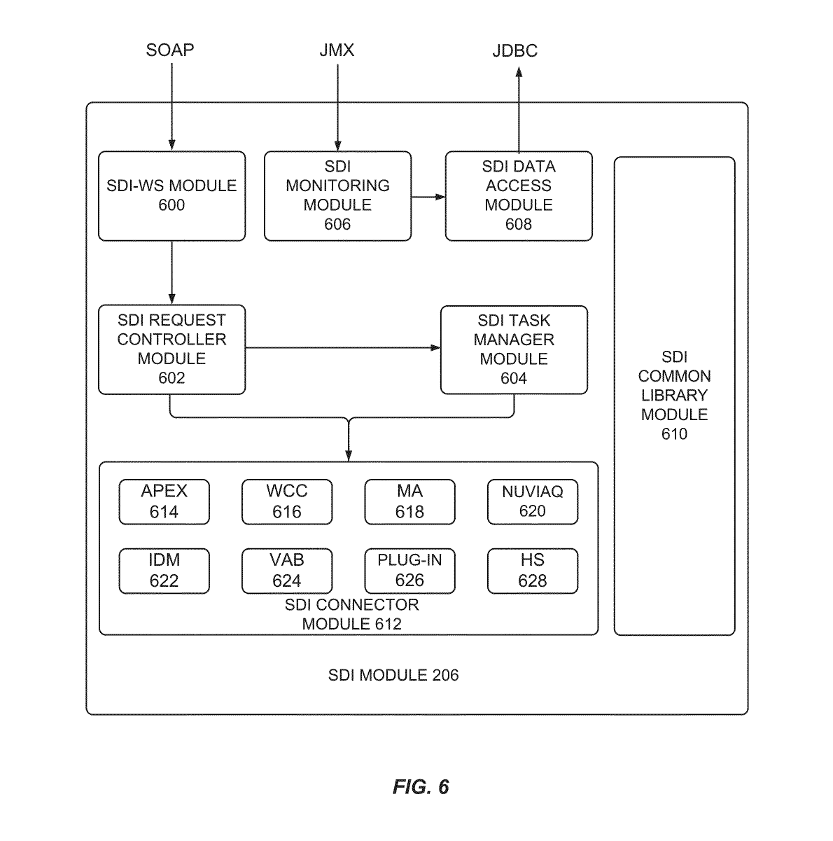

FIG. 6 depicts a simplified high level diagram of sub-modules of the SDI module according to an embodiment of the present invention. In the embodiment depicted in FIG. 6, SDI module 206 includes a SDI-Web Services (WS) module 600, an SDI request controller module 602, an SDI task manager module 604, an SDI monitoring module 606, an SDI data access module 608, an SDI common library module 610, and an SDI connector module 612. These modules may be implemented in hardware, or software, or combinations thereof. SDI module 206 depicted in FIG. 6 and its various modules are meant for illustrative purposes only and are not intended to limit the scope of embodiments of the present invention. Alternative embodiments may have more or less modules than those shown in FIG. 6. These modules and their functions are described in detail below.

SDI-WS module 600 includes capabilities for receiving a step in the business associated with an order from business process executor 316 of TAS component 204. In one embodiment, SDI-WS module 600 parses each step of the business process and converts the step into an internal representation used by SDI module 206. In one embodiment, each step of the business process associated with the order arrives through a web service processing layer (for example, via System Provisioning API discussed in FIG. 3B) in the form of a SOAP request to SDI-WS module 600.

SDI request controller module 602 is the internal request processing engine in SDI module 206 and includes capabilities for performing asynchronous request processing, concurrent request processing, concurrent task processing, fault tolerant and recovery and plug-in support related to the order requests. In one embodiment, SDI request controller module 602 accepts each step of the business process associated with the order from SDI-WS module 600 and submits the step to SDI task manager module 604.

SDI task manager module 604 translates each step specified in the business process into a series of tasks for provisioning the particular step. Once the set of tasks for a specific step have been provisioned, SDI task manager module 604 responds to business process executor 316 in TAS module 204 with operation results that includes an order payload with details of the resources provisioned to fulfill the particular step. SDI task manager module 604 repeats this process until all the steps of the particular business process associated with the order are complete.

In certain embodiments, SDI task manager module 604 translates each step specified in the business process into a series of tasks by utilizing the services of SDI connector module 612. SDI connector module 612 includes one or more connectors for handling the deployment of tasks specified by SDI task manager module 604 to provision one or more services related to the order request. In certain embodiments, one or more of the connectors may handle tasks that are specific to a particular service type while other connectors may handle tasks that are common across different service types. In one embodiment, SDI connector module 612 includes a set of connectors (wrapper APIs) that interface with one or more of the external modules (shown in FIG. 5) in cloud infrastructure system 100 to provision the services and resources related to the order request. For example, Application Express (APEX) connector 614 interfaces with APEX deployer module 504 to provision database services. Web Center Connector 616 (WCC) interfaces with a web center module in cloud infrastructure system 100 to provision web services. The web center module is a user engagement platform and includes capabilities for delivering connectivity between people and information in cloud infrastructure system 100.

In certain embodiments, Middleware Applications (MA) connector 618 interfaces with VAB module 502 in cloud infrastructure system 100 to provision middleware application services. NUVIAQ connector 620 interfaces with VAB module 502 to provision Java services. IDM connector 622 interfaces with IDM module 200 to provide identity and access management for users subscribing to services and resources in cloud infrastructure system 100. Virtual Assembly Builder (VAB) connector 624 interfaces with VAB module 502 in cloud infrastructure system 100 to configure and provision complete multi-tier application environments. Plug-in connector 626 interfaces with EM module 208 to manage and monitor the components in cloud infrastructure system 100. HTTP server connector 628 interfaces with one or more web servers in the PaaS platform to provide connection services to users in cloud infrastructure system 100.

SDI monitoring module 606 in SDI module 206 provides an inbound interface for receiving Java Management Extensions (JMX) requests. SDI monitoring module 606 also provides tools for managing and monitoring applications, system objects and devices in cloud infrastructure system 100. SDI-data access module 608 provides an inbound interface for receiving Java Database Connectivity (JDBC) requests. SDI-data access module 608 supports data access and provides object relational mapping, java transaction API services, data access objects, and connection pooling in cloud infrastructure system 100. The SDI-common library module 610 provides configuration support for the modules in SDI module 206.

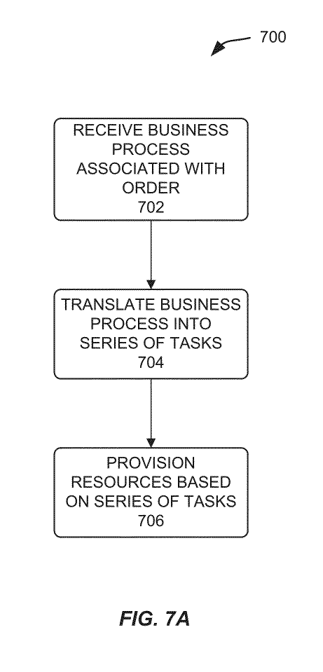

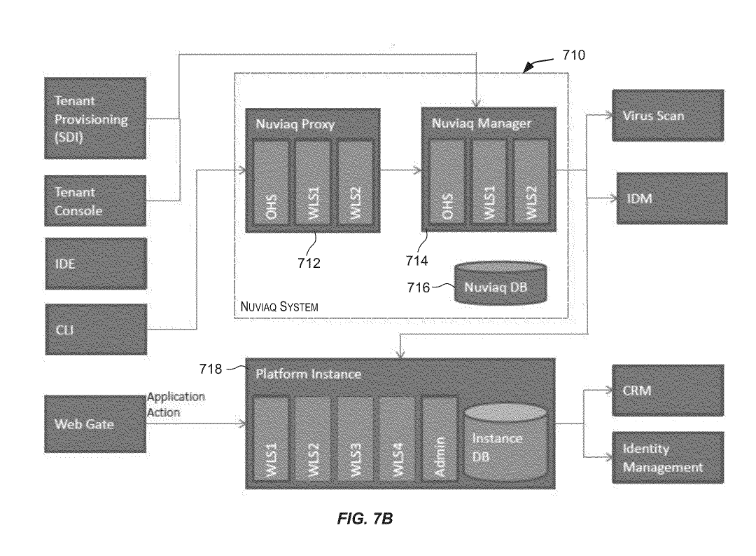

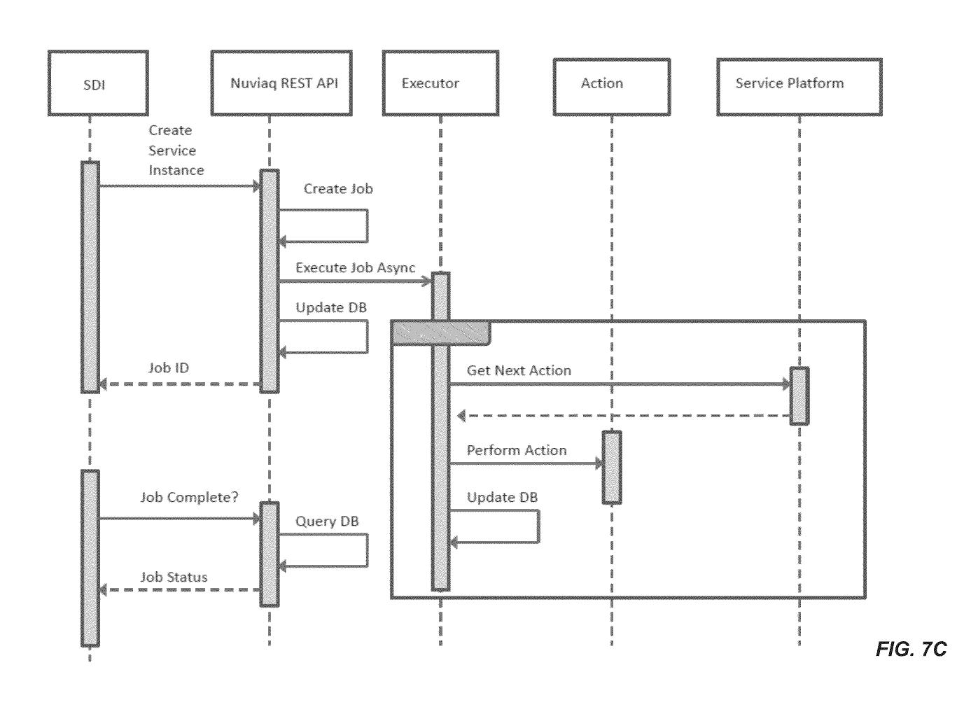

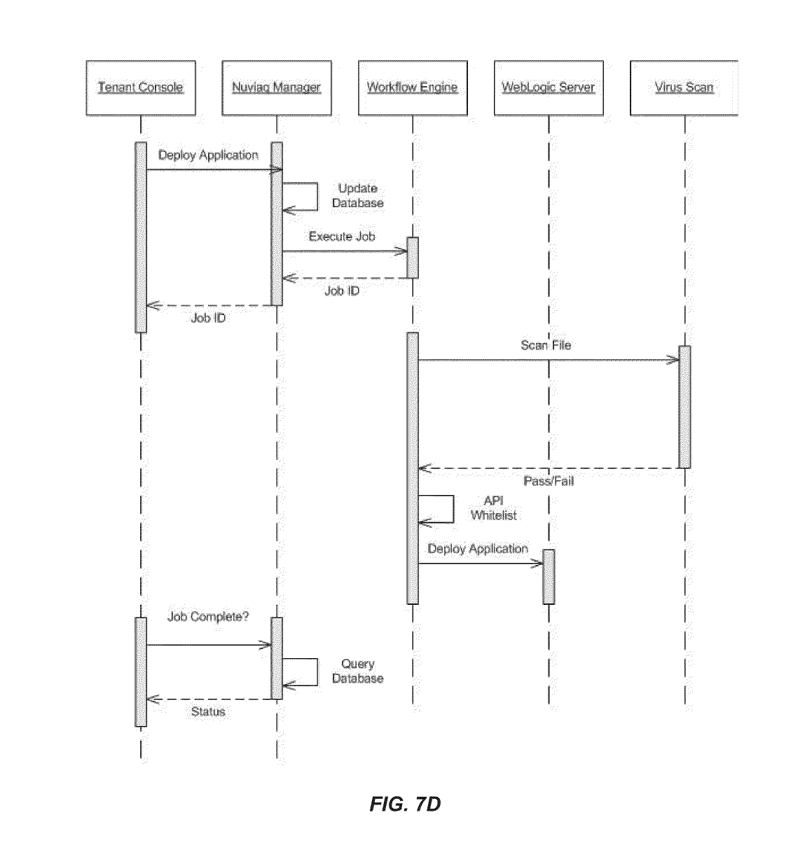

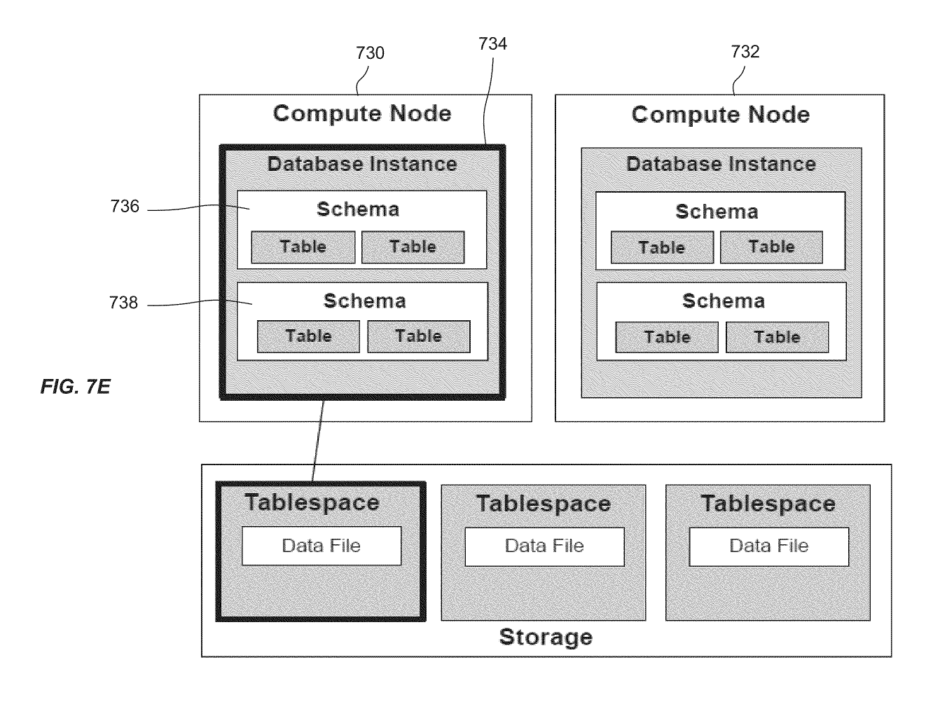

The embodiment of FIG. 6 discussed above describes modules in the SDI module according to an embodiment of the present invention. FIG. 7A depicts a simplified flowchart 700 depicting processing that may be performed by the modules of the SDI module in the cloud infrastructure system, in accordance with an embodiment of the present invention. The processing depicted in FIG. 7A may be implemented in software (e.g., code, instructions, program) executed by one or more processors, hardware, or combinations thereof. The software may be stored in memory (e.g., on a memory device, on a non-transitory computer-readable storage medium). The particular series of processing steps depicted in FIG. 7A is not intended to be limiting. Other sequences of steps may also be performed according to alternative embodiments. For example, alternative embodiments of the present invention may perform the steps outlined above in a different order. Moreover, the individual steps illustrated in FIG. 7A may include multiple sub-steps that may be performed in various sequences as appropriate to the individual step. Furthermore, additional steps may be added or removed depending on the particular applications. One of ordinary skill in the art would recognize many variations, modifications, and alternatives. In one embodiment, the processing depicted in FIG. 7A may be performed by one or more modules in the SDI module 206 discussed in detail in FIG. 6.

At 702, a business process associated with a subscription order is received. In one embodiment, SDI-WS module 600 in SDI module 206 receives one or more steps in the business process associated with the subscription order from business process executor 316. At 704, each step in the business process is translated into a series of tasks for provisioning resources for the subscription order. In one embodiment, SDI task manager module 604 in SDI module 206 translates each step specified in the business process into a series of tasks by utilizing the services of SDI connector module 612. At 706, the subscription order is provisioned based on the series of tasks. In one embodiment, and as discussed in FIG. 6, SDI connector module 612 includes one or more connectors for handling the deployment of tasks specified by SDI task manager module 604 to provision resources for the services in the subscription order.

As described above with respect to FIG. 6, SDI task manager module 604 translates each step specified in a business process into a series of tasks by utilizing the services of SDI connector module 612, which may include one or more connectors for handling the deployment of tasks specified by SDI task manager module 604 to provision one or more services related to the order request. One or more of the connectors may handle tasks that are specific to a particular service type while other connectors may handle tasks that are common across different service types. In one embodiment, SDI connector module 612 includes a set of connectors (wrapper APIs) that interface with one or more of the external modules (shown in FIG. 5) in cloud infrastructure system 100 to provision the services and resources related to the order request. For example, a NUVIAQ connector 620 interfaces with VAB module 502 to provision Java services.

FIG. 7B depicts a simplified block diagram showing the high-level architecture of a Nuviaq system 710 and its relationships with other cloud infrastructure components according to an embodiment of the present invention. It should be appreciated that Nuviaq system 710 depicted in FIG. 7B may have other components than those depicted in FIG. 7B. Further, the embodiment shown in FIG. 7B is only one example of a cloud infrastructure system that may incorporate an embodiment of the invention. In some other embodiments, Nuviaq system 710 may have more or fewer components than shown in FIG. 7B, may combine two or more components, or may have a different configuration or arrangement of components.

In certain embodiments, Nuviaq system 710 may be configured to provide a runtime engine for orchestrating PaaS operations. Nuviaq system 710 may provide a web service API to facilitate integration with other products and services. Nuviaq system 710 also provides support for complex workflows in system provisioning, application deployment and associated lifecycle operations and integrates with management and monitoring solutions.

In the embodiment depicted in FIG. 7B, Nuviaq system 710 comprises a Nuviaq proxy 712, a Nuviaq manager 714, and a Nuviaq database 716. In certain embodiments, Nuviaq manager 714 provides an entry point into Nuviaq system 710, providing secure access to PaaS operations via the web service API. Internally, it tracks system state in the database and controls job execution on the workflow engine. In a public cloud, Nuviaq manager 714 may be accessed by the Tenant Provisioning system (SDI 206) and the Tenant Console, to drive provisioning and deployment operations respectively.

In one embodiment, Nuviaq manager 714 executes jobs asynchronously via an internal workflow engine. A job may be a sequence of actions specific to a given PaaS workflow. Actions may be performed in order, with failure in any step resulting in failure of the overall job. Many workflow actions delegate to external systems relevant to the workflow, such as the EM command line interface (cli). In one implementation, Nuviaq manager 714 application may be hosted in a 2-node WebLogic cluster with associated HTTP server (e.g., Oracle HTTP Server or OHS) instance, running inside a firewall.

In certain embodiments, Nuviaq proxy 712 is the public access point to the Nuviaq API. In one embodiment, only Public API may be exposed here. Requests received by proxy 712 may be forwarded to Nuviaq manager 714. In one embodiment, Nuviaq proxy 712 runs outside the firewall, whereas manager 714 runs within the firewall. In one implementation, Nuviaq proxy 712 application runs on a WebLogic cluster running outside the firewall.

In certain embodiments, Nuviaq database 716 tracks various domain entities such as, without limitation, platform instance, deployment plan, application, WebLogic domain, jobs, alerts, and the like. Primary keys may be aligned with the Service Database where appropriate.

In one embodiment, Platform Instance 718 may contain all resources required for a WebLogic service for a given tenant.

Nuviaq system 710 may rely on additional systems of cloud infrastructure system 100 to carry out the workflows used the WebLogic cloud service. These dependencies may include dependencies on SDI 206, IDM 200, a virus scan system, a service database, CRM instances, and the like. For example, Nuviaq system 710 may depend upon functions performed by an Assembly Deployer in SDI 206. In one embodiment, the Assembly Deployer is a system to manage interactions with OVAB (Oracle Virtual Assembly Builder) and OVM (Oracle Virtual Machine). Capabilities of the Assembly Deployer used by Nuviaq system 710 may include, without limitation, functions for deploying an assembly, un-deploying an assembly, describing assembly deployment, scaling appliance, and the like. In one implementation, Nuviaq system 710 accesses the Assembly Deployer via a web service API.

In certain embodiments, security policies may require certain artifacts to be scanned for viruses before being deployed to an application. Cloud infrastructure system 100 may provide a virus scan system for this purpose that provides scanning as a service for multiple components of the public cloud.

In certain embodiments, a public cloud infrastructure may maintain a Service Database containing information about tenants (e.g., customers) and their service subscriptions. Nuviaq workflows may access to this data in order to properly configure a WebLogic service as a client to other services that the tenant also subscribes to.

Nuviaq system 710 may depend on IDM 200 for its security integration. In certain embodiments, Java Service instances can be associated with a CRM instance. The association allows user applications deployed to their Java Service instance to access a CRM instance though Web Service calls.

Various entities may use services provided by Nuviaq system 710. These clients of Nuviaq system 710 may include: a Tenant Console, which is an management server (e.g., Oracle Management Server) based user interface that customers may access to manage their applications on their platform instances; several IDEs such as Oracle IDEs (JDeveloper, NetBeans, and OEPE) have been extended to offer access to application lifecycle management operations; one or more Command Line Interfaces (CLIs) that are available to access lifecycle operations on the platform instances.

Provisioning use case for Nuviaq system 710—A Provision Platform Instance use case is realized via the Create Platform Instance operation of the Nuviaq API. In the context of cloud infrastructure system 100, a service instance with respect to the Nuviaq system corresponds to a Nuviaq platform instance. A platform instance is assigned a unique identifier is used on all subsequent operations related to this instance. A Platform Deployment descriptor provided to the Create Platform Instance action allows for properties to be set that modify the configuration of the platform instance to meet the subscription requirements of the tenant. These properties may include for example:

Property#1: oracle.cloud.service.weblogic.size
Values: BASIC, STANDARD, ENTERPRISE
Description: Specifies the subscription type. This impacts the number of servers, database limits and quality of service settings.
   Property#2: oracle.cloud.service.weblogic.trial
Values: TRUE, FALSE
Description: Indicates whether or not this is a trial subscription.
   Property#3: oracle.cloud.service.weblogic.crm
Values: CRM Service ID
Description: Identifies a CRM service to be associated with this WebLogic service instance.

FIG. 7C depicts an example sequence diagram illustrating steps of a provisioning process using a Nuviaq system according to an embodiment of the present invention. The sequence diagram depicted in FIG. 7C is only an example and is not intended to be limiting.

Install/Update Application use case—The Install Application operation deploys an application to a running WebLogic Server after validating that the application archive meets the security requirements of the Public Cloud. In one embodiment, the Application Deployment descriptor provided to the Install Application action allows for properties to be set that modify the configuration of the application to meet the subscription requirements of the tenant. These properties may include for example:

Property: oracle.cloud.service.weblogic.state

### Values: RUNNING, STOPPED

Description: Specifies the initial state of the application after deployment.

FIG. 7D depicts an example sequence diagram illustrating steps of a deployment process using a Nuviaq system according to an embodiment of the present invention. The sequence diagram depicted in FIG. 7D is only an example and is not intended to be limiting.

Referring back to FIG. 2, in certain embodiments, TAS 204 and SDI 206 working in cooperation are responsible for provisioning resources for one or more services ordered by a customer from a set of services offered by cloud infrastructure system 100. For example, in one embodiment, for provisioning a database service, the automated provisioning flow may be as follows for a paid subscription:

(1) Customer places an order for a paid subscription to a service via Store UI 210.
(2) TAS 204 receives the subscription order.
(3) When services are available TAS 204 initiates provisioning by using the services of SDI 206. TAS 204 may perform business process orchestration, which will execute the relevant business process to complete the provisioning aspect of the order. In one embodiment, TAS 204 may use a BPEL (Business Process Execution Language) Process Manager to orchestrate the steps involved in the provisioning and handle the lifecycle operations.
(4) In one embodiment, to provision a database service, SDI 206 may call PLSQL APIs in the CLOUD_UI to associate a schema for the requesting customer.
(5) After successful association of a schema to the customer, SDI signals TAS and TAS send a notification to the customer that the database service is now available for use by the customer.
(6) The customer may log into cloud infrastructure system 100 (e.g., using an URAL such as cloud.oracle.com) and activate the service.

In some embodiments, a customer may also be allowed to subscribe to a service on a trial basis. For example, such a trial order may be received via cloud UI 212 (e.g., using cloud.oracle.com).

In certain embodiments, cloud infrastructure system 100 enables underlying hardware and service instances to be shared between customers or tenants. For example, the database service may be provisioned as shown in FIG. 7E in one embodiment. FIG. 7E depicts multiple Exadata compute nodes 730 and 732, each providing a database instance provisioned for the database service. For example, compute node 730 provides a database instance 734 for a database service. Each Exadata compute node may have multiple database instances.

In certain embodiments, each database instance can comprise multiple schemas and the schemas may be associated with different customers or tenants. For example, in FIG. 7E, database instance 734 provides two schemas 736 and 738, each with its own tables. Schema 736 may be associated with a first customer or tenant subscribing to a database service and schema 738 may be associated with a second customer or tenant subscribing to the database service. Each tenant gets a completely isolated schema. Each schema acts like a container that can manage database objects including tables, views, stored procedures, triggers, etc. for the associated tenant. Each schema may have one dedicated tablespace, with each tablespace having one data file.

In this manner, a single database instance can provide database services to multiple tenants. This not only enables sharing of underlying hardware resources but also enables sharing of service instance between tenants.

In certain embodiments, such a multi-tenancy system is facilitated by IDM 200, which beneficially enables multiple separate customers, each having their own separate identity domains, to use hardware and software that is shared in the cloud. Consequently, there is no need for each customer to have its own dedicated hardware or software resources, and in some cases resources that are not being used by some customers at a particular moment can be used by other customers, thereby preventing those resources from being wasted. For example, as depicted in FIG. 7E, a database instance can service multiple customers each with their respective identity domains. Although each such database service instance can be a separate abstraction or view of a single physical multi-tenant database system that is shared among the many separate identity domains, each such database service instance can have a separate and potentially different schema than each other database service instance has. Thus, the multi-tenant database system can store mappings between customer-specified database schemas and the identity domains to which those database schemas pertain. The multi-tenant database system can cause the database service instance for a particular identity domain to use the schema that is mapped to that particular identity domain.

The multi-tenancy can also be extended to other services such as the Java Service. For example, multiple customers can have a JAVA service instance placed within their respective identity domains. Each such identity domain can have a JAVA virtual machine, which can be viewed as being a virtual “slice” of hardware. In one embodiment, a job-monitoring service (e.g., Hudson) can be combined with a JAVA enterprise edition platform (e.g., Oracle WebLogic) in the cloud to enable each separate identity domain to have its own separate virtual “slice” of the JAVA enterprise edition platform. Such a job-monitoring service can, for example, monitor the execution of repeated jobs, such as building a software project or jobs run by an operating system's time-based job scheduler. Such repeated jobs can include the continuous building and/or testing of software projects. Additionally or alternatively, such repeated jobs can include the monitoring of executions of operating system-run jobs that are executed on machines that are remote from the machine on which the job-monitoring service executes.

### Reusable Anonymous Subscriptions (RASs)

In certain embodiments, cloud infrastructure system 100 enables underlying hardware and service instances to not only be shared between customers or tenants but also to have existing subscriptions reused by other customers or tenants without having to completely provision new resources. In one aspect, a reusable anonymous subscription (RAS) is a type of subscription that enables a customer to access a service that has already been provisioned prior to a request to access the service. In some embodiments, a RAS may have been used by a different customer to access the service. After using the RAS to access the service, the RAS may be reassigned to another customer. The resources for the service accessible using the RAS may remain provisioned for that RAS for reuse by a different customer that is provided that RAS.

In some embodiments, a RAS enables a customer to use a service before purchasing a subscription (e.g., a regular subscription) to the service. The access provided by the service for a RAS may be different (e.g., limited) from that of a regular subscription. For example, a RAS may enable a customer to access a service as a guest for temporary use (e.g., testing or trial use) before purchasing a subscription for the service. A RAS may be useful to enable a customer to try a service without having to actually pay for the service.

In some aspects, a RAS may be configured differently from a regular subscription such that the use of a RAS may be to try a service. In some embodiments, a RAS may not provide all features available to a customer assigned a regular subscription. In one example, updating and expanding operations may not be supported for a RAS, i.e. the customer cannot add new features or increase the size of a RAS (e.g., user count), whereas some or all of those features may be accessible to a customer assigned a regular subscription. In another example, support such as high availability and disaster recovery features may not be available (e.g., disabled) to customer assigned a RAS. In another example, a RAS may not permit phased deployment of a service accessed by a customer for a RAS. In a phased deployment, the subscription configuration is changed based on a predefined deployment plan. In another example, a RAS customer may not be allowed to incur overages. In yet another example, notifications such as usage related alerts may not be available to a customer assigned a RAS.

When a customer decides not to convert a RAS to a regular subscription, the RAS can be reassigned to another customer for reuse of the RAS. The service provisioned for the RAS will remain provisioned when the RAS is returned by the customer, thereby minimizing the time to provision new resources for the service as well as maximizing resource usage.

If a customer agrees to obtain a regular subscription for the service accessed using a RAS, cloud infrastructure system 100 may convert the RAS to a regular subscription. In various embodiments, cloud infrastructure system 100 may implement a conversion process (e.g., a lightweight personality injection process) to convert the RAS to a regular subscription. The conversion process may retain the resources provisioned for the RAS to prevent re-provisioning of resources for the service provided by the RAS. Hence, a RAS may be very useful for complex products (e.g., CRM system) which are provisioned using a heavy-weight process. The conversion process may retain the data generated by the customer using the service accessed via the RAS. The retained customer data may be used by the customer for the service accessed using the regular subscription. By retaining the customer data, the customer may save time and resources that would be used to regenerate the customer data based on the customer's use of the service.

In another aspect, customer-specific data generated during use of a service provided by a RAS may be separated from service-specific data related to the service provided by the RAS. In some embodiments, when a RAS is not converted to a regular subscription, the service-specific data for the service provided by that RAS may be maintained in association with the RAS and the customer-specific data may be disassociated with the RAS. When the RAS is converted to a regular subscription, the customer-specific data may be retained and associated with the regular subscription. As such, the user provided with the regular subscription may continue use of the service with existing customer-specific data generated when the service was accessed using the RAS. A RAS may be distinguished from a trial subscription that is usually not reusable by different customers; rather the trial subscription is decommissioned at the end of a trial period.

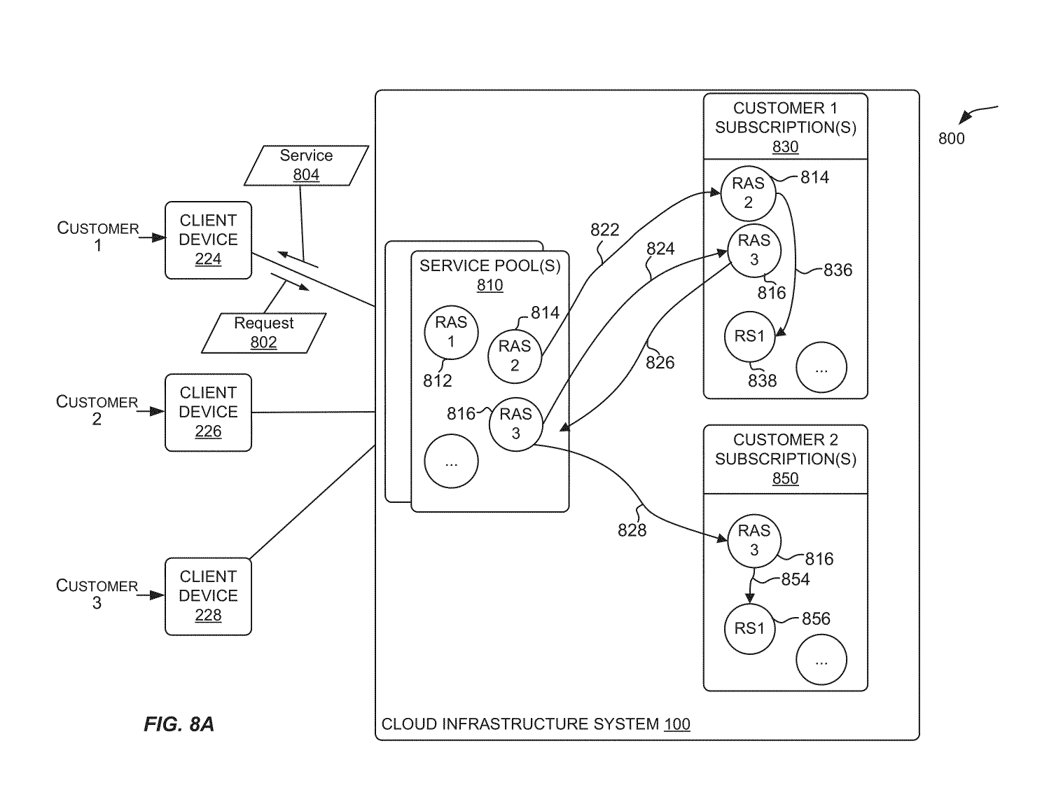

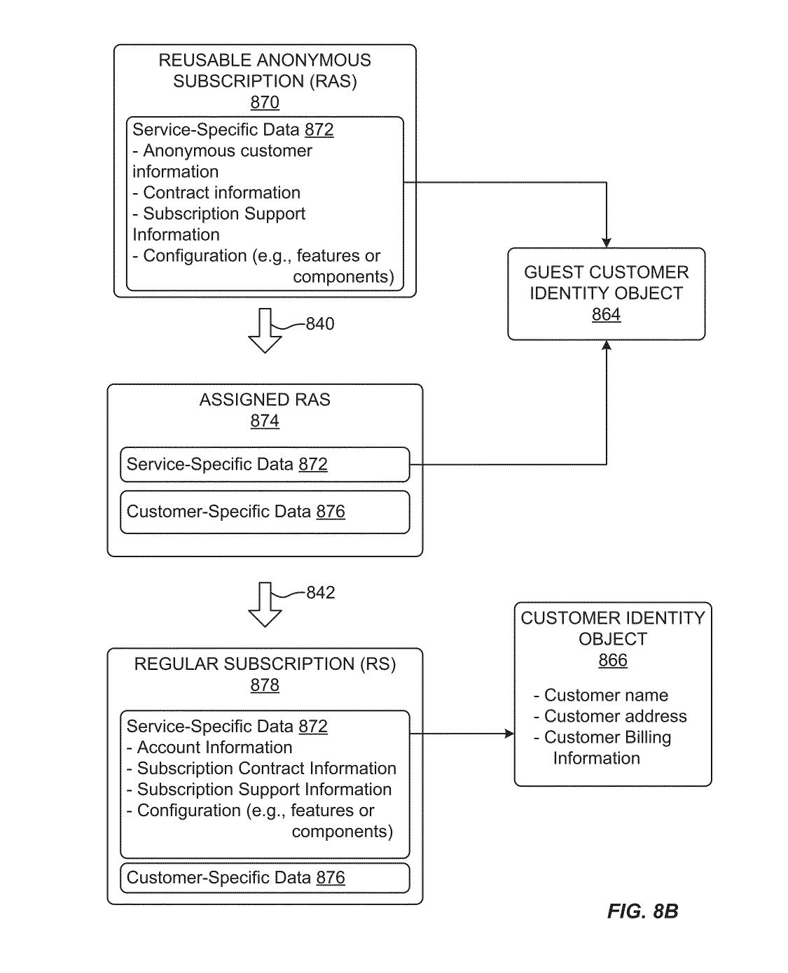

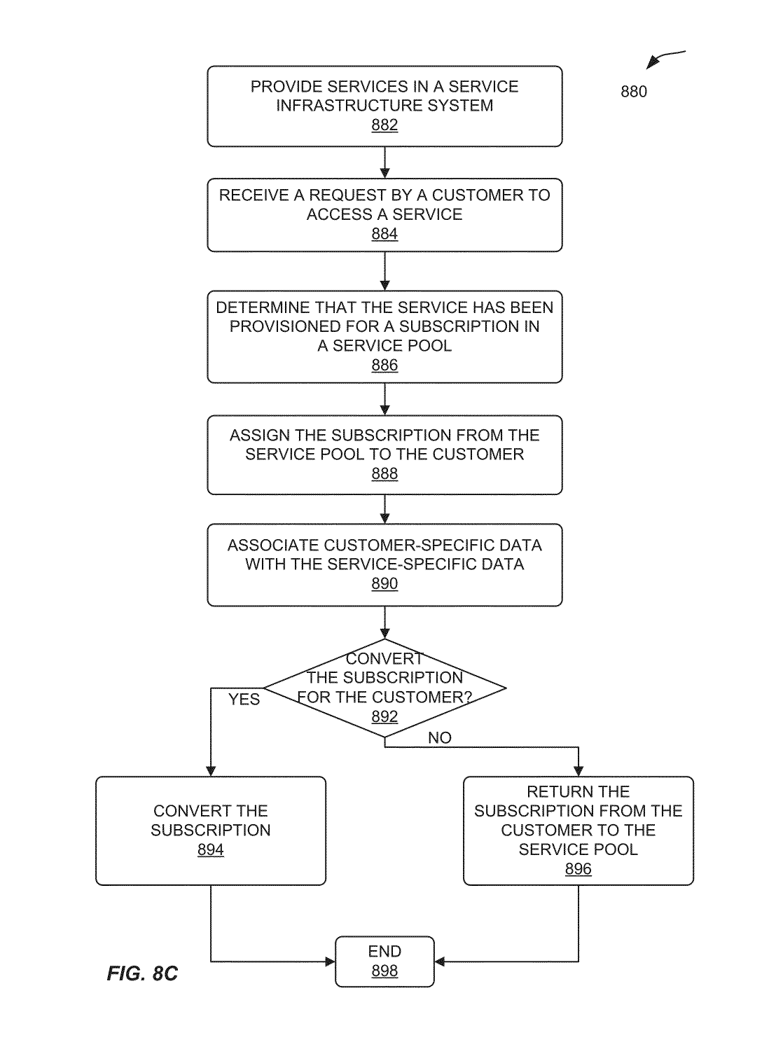

Now turning to FIGS. 8A-8C, various embodiments are depicted for providing a RAS to a customer according to some embodiments of the present embodiment. FIG. 8A depicts a simplified block diagram of a system environment 800 for providing reusable anonymous subscriptions according to some embodiments of the present invention. FIG. 8B depicts an example of data structures for implementing reusable anonymous subscriptions according to some embodiments of the present invention. FIG. 8C is a flowchart of a process for managing the lifecycle of a reusable anonymous subscription according to various embodiments.

In FIG. 8A, system environment 800 is shown with several customers, such as a customer 1, a customer 2, and a customer 3 associated with client device 224, client device 226, and client device 228, respectively, for communication with cloud infrastructure system 100. Cloud infrastructure system 100 may manage one or more service pools (e.g., service pool 810) of RAS subscriptions for customers. Service pool 810 may include one or more RASs, such as RAS 812 (“RAS1”), RAS 814 (“RAS2”), and RAS 816 (“RAS3”), each of which are available to be assigned to a customer. In some embodiments, one or more service pools (e.g., RAS pools) may be created to provide RASs to enable access to services that have already been provisioned.

In various embodiments, a service pool may be established based on a configuration or template (e.g., a product template). For example, a service pool may be established and maintained for a specific product configuration. If a customer needs a RAS for a product configuration for which no RAS pool exists, a new service pool may be created for this product configuration and a new RAS is added to the service pool. If one or more additional RASs are created in the future for the same product configuration, they may also be added to that service pool. A template may incorporate resource constraints that are imposed on access (e.g. a limit on number of users, a limit on storage, or the like) to a product (e.g., a service). For example, one service pool may be configured based on a product configuration template for the database as a service (DBAAS) product and another service pool may be configured based on a product configuration template for the CRM service product. In some embodiments, a service pool may include additional pools, each of which are further defined based on a category. In the previous example, a service pool for a DBAAS service pool could have separate service pools, each of which provides a different type of RAS for the DBAAS, such as DBAAS basic, DBAAS standard, and DBAAS enterprise. Alternatively, separate pools can be created for different types of subscriptions, either for the same or different products.

In some embodiments, a service pool may be associated with or categorized based on one or more criteria. The criteria may be indicated by a template used for configuring a service pool. A template may be based on a type of service, the resources provisioned for the services made available by the service pool, a type of subscription, number of subscriptions, availability of resources, or the like. A service corresponding to each RAS in a service pool may be provisioned before a subscription order is processed for a service in that service pool.

In one aspect, a template used to define a service pool may be determined based on feedback provided by various components of cloud infrastructure system 100. For example, the rate at which customers are placing orders may be determined and used to influence a number of subscriptions allocated to a pool. In another example, the type of service may be used to allocate X number of subscriptions for a first type and a different number of subscriptions of a second type. Other performance, marketing, and customer-related metrics can be used to determine the number of available subscriptions and how the subscriptions are pre-allocated. Furthermore, cloud infrastructure system 100 can dynamically increase or decrease the number of RASs available in a service pool based on analysis of feedback determined by cloud infrastructure system 100.

In some embodiments, a RAS can also be created based on a customer-specific product template configured based on a customer's need. The customer-specific RAS may be stored in a service pool designated for one or more customers. In some embodiments, the customer-specific RAS may be reused by other customers that may have a need satisfied by the customer-specific RAS. In some embodiments, a service pool may be created for services that are configured like the customer-specific RAS. Other RASs created with a similar configuration as the customer-specific RAS may be added to the service pool. Customer-specific RASs may be stored in a service pool designated for a customer that configured the customer-specific RASs.

As explained above, TAS module 204 of cloud infrastructure system 100 functions as an orchestration component that manages business processes associated with each subscription order and applies business logic to determine whether a subscription order should proceed to provisioning. TAS module 204 handles processing to process a subscription order based on a request by a customer for a service. In some embodiments, TAS module 204 can determine that a request (e.g., request 802) has been made for a service for which access may be provided by a RAS. TAS module 204 may establish an environment for the requested service based on the type of use indicated by a request from a customer. TAS module 204 can determine that a RAS has been requested based on an explicit request for a RAS indicated by the request received from the customer.

A request (e.g., request 802) for a service from cloud infrastructure system 100 may include information that may be used to provide the service. Specifically, a request may include information (e.g., order information) that enables cloud infrastructure system 100 to determine a RAS to provide a customer for a requested service. In some embodiments, a request may indicate a type of service or a type of use intended for a requested service. Examples of the type of use include, but may not be limited to, development, testing, training, prototyping, load balancing, marketing, sales, design, production, etc.

In some embodiments, a request may indicate one or more requirements for the requested service. The requirement(s) may include a fee constraint (e.g., a minimum fee and/or a maximum fee), a time limit for use of the requested service, an amount of users that will use the service, a type of service support desired, other requirements related to use of a service, or combinations thereof. Cloud infrastructure system 100 may determine, based on the requirements indicated by a request from a customer, a subscription to provide a customer to enable access to the requested service. At least one example of a subscription provided to a customer may be a RAS.

TAS module 204 may implement operations to establish a RAS to enable access to a requested service. In an example shown in FIG. 8A, cloud infrastructure system 100 may determine whether a requested service has been provisioned for a RAS in one or more service pools (e.g., service pool 810). Processing may be performed to analyze available subscriptions (e.g., a RAS) in one or more service pools to determine whether an available subscription provides access to the requested service. A service pool may include multiple RASs, each of which may be assignable to a customer when the RAS is available. Each RAS may be inspected to determine the resources and/or the service(s) provided by the RAS. A subscription, such as a RAS, may be identified in a service pool based in part on information determined from the request (e.g., a type of subscription requested by a customer, a type of use of the requested service, a duration of the requested service, or combinations thereof).

In some embodiments, a service pool may be established for a specific geographical location (e.g., a geographical region). The geographical location may be defined based on a geographical location of a data center. A service pool may be established for a geographical location due to legal and/or compliance reasons. A service pool may be established for a geographical location when no service pools have been established for the geographical location. In some embodiments, service pools established in a geographical location may be further defined based on product configuration. For example, a service pool may be configured for a geographical location for RASs having a specific product configuration. In such embodiments, a service pool for a geographical location may be created for a new RAS when no existing service pool in the geographical location is defined for the product configuration of the new RAS.

When a RAS matching the customer's request cannot be found, a new RAS may be provisioned based on the customer's request. The newly provisioned RAS may be added to an appropriate service pool. A service pool may be expanded to include new RASs to meet the demands of customers. The new RAS may then be assigned to the customer.

In some embodiments, the provisioned RAS may not be added to an existing service pool. For example, a RAS may not be added to a service pool when existing service pools are full due to resource capacity. In some embodiments, a RAS may not be added to a service pool when a product configuration of the provisioned RAS does not meet the classification of a service pool. The RASs in the existing service pools may be configured for a type of subscription or a type of use that does not match the configuration of the new RAS. In one example, a provisioned RAS may not be assigned to existing service pools when a product configuration of the RAS does not match a product configuration of existing service pools. In some embodiments, the product configuration of the newly created RAS may not match the product configuration of each of the existing service pools because the product configuration of the new RAS is different from the product configuration of the RASs in each of the existing service pool. In such instances, a new service pool may be established on-demand.

In some embodiments, a service pool may be customer-specific, such that the service pool includes RASs configured according to a custom template for a customer. In this embodiment, the RASs in such a service pool may only be assigned to the specific customer designated for that service pool.

In some embodiments, determining whether a requested service has been provisioned may include determining a service pool corresponding to a type of service pool. The type of service pool may be identified based on information indicated by the request from a customer. For example, a type of service pool may be determined based on the requested service, a type of subscription (e.g., a RAS subscription) requested by a customer, a type of use of the requested service, or combinations thereof, any or all of which may be indicated by a request.

In one example shown in FIG. 8A, TAS module 204 may determine that one or more RASs, e.g., RAS2 814 and RAS3 816, in service pool 810 are available to be assigned to a customer (e.g., customer 1) for one or more requested services. TAS module 204 may implement operations to assign 822 a first RAS (e.g., RAS2 814) to customer 1 for a first service and to assign 824 a second RAS (e.g., RAS3 816) to customer 1 for a second service. Subscriptions assigned to a customer may be maintained in storage associated with the customer, such as subscriptions 830 (“customer 1 subscriptions”). In some embodiments, customer-specific data associated with a service accessed using a RAS may be stored in association with data related to the service (e.g., service-specific data). Examples of data structures for storing subscriptions are described with reference to FIG. 8B.

A RAS may be returned to a service pool when a customer has completed using the RAS. In some embodiments, a RAS may be associated with one or more requirements related to use of the RAS. For example, the requirement(s) may be related to use of resources enabled for the RAS or to a time period for enabling access to a service. A RAS may be returned to a service pool when the requirement(s) of the RAS have been satisfied. For example, RAS3 816 may be returned 826 to service pool 810. The service-specific data associated with RAS3 816 may be maintained in storage while the customer-specific data generated by customer 1's use of RAS3 816 may be discarded. Returning a RAS may include assigning the RAS to the service pool. In some embodiments, a RAS may be returned to a service pool from which the RAS was obtained. However, a RAS may be returned to a different service pool based on allocation of RASs to a service pool.

Cloud infrastructure system 100 may convert an assigned RAS to a regular subscription (RS). A RAS may not be returned to a service pool when that RAS is converted to a RS. A RAS may be converted to a RS based on input received from a client device operated by a customer. In some embodiments, cloud infrastructure system 100 may send information to a client device to cause the client device to prompt a customer to provide a preference for converting a RAS to a RS. An RS may enable a customer to continue use of a service accessed using the RAS. In one example shown in FIG. 8A, RAS2 814 may be converted 836 to RS1 838 based on input received from a client device operated by customer 1. Conversion of an assigned RAS to a RS is explained further below with reference to FIGS. 8B and 8C.

A RAS that was assigned to a customer and returned to a service pool may be assigned to a customer for a requested service. The customer may be the same that was previously assigned the RAS or a different customer. Continuing with the previous example described with reference to in FIG. 8A, once RAS3 816 is returned to service pool 810, RAS3 816 may be assigned 828 to another customer (e.g., customer 2). Subscriptions assigned to customer 2 may be maintained in storage associated with that customer, such as subscriptions 850 (“customer 2 subscriptions”). The service-specific data associated with RAS3 816 may be retained after RAS3 816 is returned to service pool 810 and assigned to customer 2. Customer-specific data that is generated based on access to a service using RAS3 816 may be stored in association with service-specific data associated with RAS3 816. RAS3 816 may be returned to service pool 810 or may be converted to a RS. In the example of FIG. 8A, RAS3 816 may be converted 854 to RS1 856. In this case, RAS3 816 is no longer available to be reassigned to a customer since RAS3 816 is not returned to service pool 810. By converting RAS3 816 to RS1 856, the customer-specific data generated by customer 2 may be retained for use with RS1 856.

Now turning to FIG. 8B, an example is depicted of data structures for implementing reusable anonymous subscriptions according to some embodiments of the present invention. One or more data structures may be implemented by cloud infrastructure system 100 to store data related to subscriptions. Examples of data structures includes, without limitation, a linked list, a table, an array, a hash table, a graph, and the like.

RAS 870 is an example of a data structure that can store information about a RAS. RAS 870 may be stored in a memory allocated for a service pool. In the example of FIG. 8B, RAS 870 is shown with data about a single RAS. However, RAS 870 can store information about one or more RASs. One or more data structures may be implemented for a RAS in a modular manner to facilitate a lightweight conversion process that enables reusability of the RAS for multiple customers.

RAS 870 may include data corresponding to a service (e.g., service-specific data 872) provisioned for a RAS. Service-specific data 872 may contain data related to providing the service enabled for RAS. Service-specific data 872 may be customer-neutral such that it can be reused for different customers. For example, service-specific data 872 may include product-specific metadata related to a product (e.g., a service or a component) provided by the RAS corresponding to RAS 870.

In some embodiments, service-specific data 872 may indicate a configuration (e.g., a physical configuration of resources) for a service provided for the subscription. A configuration may indicate resource constraints, such as one or more components (e.g., features) enabled or disabled for a service. A configuration may be determined based on a template for a type of service or a product associated with the service. In some embodiments, the configuration may be based on a generic product template in contrast to a configuration for a regular subscription that may be based on customer preference (e.g., a configuration that has been purchased).

In some embodiments, service-specific data 872 may include information related to a RAS. Among other information, service-specific data 872 may identify a subscription, such as a name of a subscription and/or an identifier of a subscription. Service-specific data 872 may include customer information related to an anonymous user. For example, service-specific data 872 may include a reference to a data structure (e.g., guest customer identity objet 864) that includes information for a guest assigned RAS 870. Service-specific data 872 may include contract information. A RAS may not have an effective start date and/or end date so that it can be reused across customers. In contrast, a regular subscription may be assigned with an effective start date and/or end date for which the regular subscription has been purchased by the customer.

Service-specific data 872 may indicate a type of support for the RAS. Since a RAS may be used in a limited capacity until it is converted to a regular subscription, a RAS may enable a level of support that is different from a regular subscription. For example, a generic level of support may be provided to a customer assigned the RAS, whereas a premium level of support may be provided to a customer that purchases a regular subscription.

In some embodiments, service-specific data 872 may indicate operations that can be performed using the RAS. For example, service-specific data 872 may indicate that testing can be performed using the RAS to determine whether the service provided by the RAS can support a customer's workflows. Additionally or alternatively, a RAS may provide other uses such as enabling a customer to demo a service and/or compare the service with similar services provided by one or more competitors.

When RAS 870 is assigned 840 to a customer, cloud infrastructure system 100 may maintain a data structure 874 (Assigned RAS). RAS 870 may be stored as assigned RAS 874. Assigning a RAS may include moving a location of RAS 870 to a new location in storage associated with a customer. Alternatively, assigned RAS 874 may include a reference in storage to RAS 870. In some embodiments, assigned RAS 874 may be implemented as a different data structure that includes data in RAS 870. In some embodiments, a data structure (e.g., a mapping table or a hash table) may be implemented in addition to RAS 874 to store a reference to each assigned RAS 874 associated with a customer.

Although assigned to a customer, service-specific data 872 in assigned RAS 870 may indicate an anonymous customer identity since the RAS subscription has not been converted. For example, service-specific data 872 may indicate a reference to data structure 864 (guest customer identity object) that stores identity information about a guest. In some embodiments, guest customer identity object 864 may include information about a guest, such as a guest's name, contact information, or the like.

Assigned RAS 874 may be modified to store customer-specific data 876 for the customer assigned RAS 870. Customer-specific data 876 may include data corresponding to use of a service accessed using the RAS corresponding to RAS 870. Customer-specific data 876 may be based on an application used to access the service. For example, customer-specific data 876 may include customer mailboxes corresponding to a sales cloud service accessed by a subscription to the service. In another example, customer-specific data 876 may include tables generated by use of a database service. In another example, customer-specific data 876 may include storage objects for an object storage service accessed using the RAS. In some embodiments, the actual customer-specific data may be stored in a separate service-specific repository and customer-specific data 876 may store references to this customer-specific data stored in the service-specific repository.

Cloud infrastructure system 100 may implement a conversion process 842 (e.g., a lightweight personality injection process) to convert a RAS to a regular subscription (RS). For example, a RAS corresponding to RAS 874 may be converted to a RS represented by data structure 878. Conversion process 842 may include changing a type of subscription corresponding to assigned RAS 874. For example, RS 878 may indicate access to the same service provided by assigned RAS 874 except under different terms (e.g., an extended period) as a regular subscription than the terms of a RAS corresponding to assigned RAS 874. Conversion process 842 may store information in assigned RAS 874 into RS 878. In some embodiments, storage of assigned RAS 874 may be updated to indicate that assigned RAS 874 is a RS, e.g., RS 878.

Conversion process 842 may include determining account information (e.g., an account footprint) for a subscription (e.g., a regular subscription) to which the subscription assigned to the customer is converted. For example, order management module 214 of cloud infrastructure system 100 may determine account information for the customer. Determining account information may include creating an account for the customer. An account may be created when no existing account can be found for the customer based on the customer's identity information. Upon discovering an existing account, the existing account may be updated for to enable access to the subscription that is converted. Accordingly, service-specific data 872 in RS 878 may be updated with account information corresponding to the converted subscription.

Conversion process 842 may include storing customer information (e.g., injecting personality information) in association with RS 878. RS 878 may be associated with or may refer to customer identity information of a customer associated with assigned RAS 874. In cloud infrastructure system 100, information about a customer's identity may be stored in a data structure 866 (customer identity object). In the example shown in FIG. 8B, RS 878 may indicate a reference to customer identity object 866 identifying the customer associated with assigned RAS 874. Other subscriptions (e.g., other RASs) assigned to a customer may store a reference to customer identity object 866. A customer identity object (e.g., customer identity object 866) may include data indicating information about a customer. The data may indicate a customer's identity (e.g., name or user identifier), a customer's contact information, a customer's billing information, other customer related information, or combinations thereof.

In some embodiments, conversion process 842 may include updating guest customer identity object 864 with information in customer identity object 866. Processing time may be reduced for converting a RAS to a RS by storing information about a customer's identity in a symbolic manner using a reference to an object. Alternatively, a reference from service-specific data 872 to guest customer identity object 864 may be updated to indicate a reference to customer identity object 866.

Conversion process 842 may include determining a contract for a regular subscription (e.g., RS 878) converted from a RAS (e.g., assigned RAS 874) for the customer. For example, order management module 214 may perform processing to determine a contract for the type of subscription provided by RS 878. Determining a contract may include determining a subscription duration and entitlement information for one or more entitlements provided by RS 878. The contract may subject the customer to terms and conditions that may be associated with a regular subscription, such as entitling the customer to regular product support. The terms may indicate a term of use of the service consistent with the subscription that is paid. A regular subscription converted from a RAS may provide the customer with usage quota limits that are greater than the quota limits provided by the RAS.

Conversion process 842 may further include establishing support information in support sys 217 of cloud infrastructure system 100. The account information for a regular subscription (e.g., RS 878) assigned to the customer may be provided to the support system to allow the customer to receive support (e.g., regular product support) provided by the regular subscription.

In some embodiments, conversion process 842 may include injecting the account information for the customer into TAS 204 and the physical provisioning layer. For example, TAS 204 tags the subscription footprint and the identity domain with the customer account number.

FIG. 8C is a flowchart 880 of a process for managing the lifecycle of a reusable anonymous subscription according to various embodiments. In some embodiments, the process depicted by flowchart 880 may be implemented by all or part of a service infrastructure system (e.g., cloud infrastructure system 100).

The processing depicted with reference to FIG. 8C may be implemented in software (e.g., code, instructions, program) executed by one or more processors, hardware, or combinations thereof. The software may be stored in memory (e.g., on a memory device, on a non-transitory computer-readable storage medium). The particular series of processing steps depicted in FIG. 8C is not intended to be limiting. Other sequences of steps may also be performed according to alternative embodiments. For example, alternative embodiments of the present invention may perform the steps outlined above in a different order. Moreover, the individual steps illustrated in FIG. 8C may include multiple sub-steps that may be performed in various sequences as appropriate to the individual step. Furthermore, additional steps may be added or removed depending on the particular applications. One of ordinary skill in the art would recognize many variations, modifications, and alternatives. The process depicted by flowchart 880 begins in at block 882.

At block 882, one or more services are provided in a service infrastructure system (e.g., cloud infrastructure system 100 of FIG. 1). The service infrastructure system may include or implement a multi-tenant environment. Examples of services may include a CRM service, a HCM service, a Java® service, or other computing services.

Each service of the provisioned services may be associated with service-specific data (e.g., service-specific data 872 of FIG. 8B). The service-specific data corresponding to a service may indicate a configuration for the service. The configuration may include one or more resources allocated to provide the service.

In some embodiments, providing one or more services includes provisioning one or more of the services in the service infrastructure system prior to receiving a request by a customer to access one of the services. A service may be provisioned based on one or more criteria. For example, a service may be provisioned based on one or more metrics related to operation of the service infrastructure system. In another example, a service may be provisioned based on one or more metrics associated with demand for the service. In yet another example, a service may be provisioned based on one or more metrics associated with the type of the service.

In some embodiments, one or more service pools may be created to provide access to services that have already been provisioned. As explained earlier, a service infrastructure system may maintain a plurality of service pools. A service pool may include a plurality of subscriptions. Each of the plurality of subscriptions may be associated with at least one service provided by a service infrastructure system. In one example, a service pool may provide a plurality of RAS subscriptions. In some embodiments, a service pool may be associated with or categorized by a type of service, the resources provisioned for the services made available by the service pool, a type of subscription, or the like. A service corresponding to a subscription in a service pool may have been provisioned by the service infrastructure system before a request is made for that service.

A request to access a service by a customer is received at block 884. For example, request 802 may be received from client device 224. The request may indicate the requirements for a service that is requested. For example, the request may include information indicating a type of use for the requested service. The type of use may be used by a service infrastructure system to determine the service requested by a customer.

In various aspects, a customer can be presented with a variety of options at a user interface at a client device when requesting a service. One option may include choosing whether all or part of a requested service is to be provisioned. Another option may include a type of subscription (e.g., a RAS subscription or a production subscription) that is desired for the requested service.

At block 886, processing is performed to determine that the requested service has been provisioned for a subscription in a service pool (e.g., service pool(s) 810) in a service infrastructure system. Processing may be performed to analyze available subscriptions (e.g., a RAS) in one or more service pools to determine whether an available subscription provides access to the requested service. As explained above, a service pool may include multiple RASs, each of which may be assignable to a customer when the RAS is available. Each RAS may be inspected to determine the resources and/or the service(s) provided by the RAS. A subscription, such as a RAS, may be identified in a service pool based in part on information determined from the request (e.g., a type of subscription requested by a customer, a type of use of the requested service, a duration of the requested service, or combinations thereof). Service-specific data corresponding to each subscription in a service pool may be processed to identify a subscription having a type of subscription for the service (e.g., a RAS subscription) requested by a customer. Processing may be performed to determine whether an available subscription in the service pool can provide access to the requested service.

Determining that the requested service has been provisioned may include determining a service pool from a plurality of service pools that provide a subscription for a service such as the requested service. In some embodiments, a service pool may be designated to provide one or more subscriptions (e.g., one or more RASs) for a type of service. As such, determining a service pool may include identifying a service pool that may provide RAS(s) for accessing the requested service. The identified service pool(s) may be inspected to determine whether any RAS in those service pools enable access to the requested service.

In some embodiments, the determination of a service pool from multiple service pools may be based on availability, in at least one service pool, of a subscription to the service requested by the user. For example, a service pool may be determined from a plurality of service pools based on a type of service pool. A type of service pool may be determined based on information indicated by the request from a customer (e.g., the request received at block 884). For example, a type of service pool may be determined based on the requested service, a type of subscription (e.g., a RAS subscription) requested by a customer, a type of use of the requested service, or combinations thereof, any or all of which may be indicated by a request.

At block 888, a subscription for access to the requested service may be assigned from a service pool (e.g., the service pool determined at block 886) to the customer. For example, RAS3 816 in FIG. 8A may be assigned 824 to customer 1. When a subscription, such as a RAS subscription is assigned to a customer, data related to the subscription, e.g., service-specific data included in the RAS, may be stored in association with information about the subscription assigned to the customer. For example, RAS 870 of FIG. 8B may be assigned to a customer as assigned RAS 874. In this example, service-specific data 872 may be stored with assigned RAS 874 stored for the assigned RAS subscription. Assigning a subscription to the requested service from the service pool to the customer may include removing that subscription from the service pool.

In some embodiments, the availability of subscriptions (e.g., RAS subscriptions) in a service pool may change based on demand from customers. As such, a subscription (e.g., a RAS subscription) to access the requested service may not be available when the request is received. In some embodiments, a service requested by a customer may be assigned from the determined service pool to the customer when a subscription to access that service is returned to the service pool (e.g., a subscription to the service is reassigned from a customer to the service pool).

At block 890, customer-specific data corresponding to a customer (e.g., the customer that requested a service) may be associated with service-specific data corresponding to the requested service. As explained above, customer-specific data includes data generated by use of a service (e.g., a service provided by a subscription). The customer-specific data, when generated, may be stored in association with the service-specific data for the subscription providing access to the service used to generate that data. In at least one example, customer-specific data 876 related to use of a service provided by a subscription corresponding to assigned RAS 874 may be stored in association with service-specific data 872 in assigned RAS 874.

By storing customer-specific data in association with service-specific data for a RAS, the customer-specific data can be preserved for a service provided by a RAS if and when the RAS is converted to a regular subscription. Further, the customer-specific data may be associated with service-specific data so as to prevent loss of customer-specific data when access to the RAS service is modified. The customer-specific data may be maintained from a RAS subscription to a regular subscription (e.g., a production subscription) if the RAS subscription is converted to extend access for a different subscription.

Processing is performed to determine whether to convert the subscription (e.g., a RAS subscription) for the customer. A subscription may be converted by a conversion process (e.g., a lightweight personality injection process), such as conversion process 842 described with reference to FIG. 8B. The conversion process may include changing a type of subscription assigned to the customer for accessing the service previously provided by the subscription (e.g., the subscription assigned at block 888). For example, the subscription may be converted to a regular subscription, which may provide access to the service under different terms than the terms of the subscription assigned from the service pool.

A subscription may be converted for many reasons. For example, a customer may indicate that he wishes to purchase a subscription to use a service for a time period. In another example, a customer may indicate that he wishes to obtain more than a generic level of service support for a service and therefore, may choose to convert a subscription to one that provides premium support for a service.

In some embodiments, a determination whether to convert the subscription for a customer may be based on input received from a customer. For example, cloud infrastructure system 100 may request input from the customer indicating a decision whether to convert a subscription. The customer may provide the input indicating whether to convert the subscription. The input may indicate one or more criteria for converting the subscription. The criteria may indicate a term of a subscription to which the subscription will be converted. The criteria may indicate other preferences for a subscription, such as a fee, a type of service, a type of support, or other criteria related to a type of subscription. In some embodiments, a customer may have provided input with the request received at block 884. In that request, the customer may have indicated when and how the subscription is to be converted.

In some embodiments, a determination whether to convert the subscription for a customer may be determined by a service infrastructure system. The service infrastructure system may determine whether to convert the subscription to a different type of subscription based on information determined by the service infrastructure system. In some embodiments, a customer may provide one or more rules indicating when and how a subscription is to be converted. For example, the determination may be made based on variety of factors, including, but not limited to, metrics related to operation of the service infrastructure system for the service, one or more metrics associated with demand for the service, one or more metrics associated with the type of the service, or combinations thereof. The metrics may be defined by the rule(s) provided by a customer.

Upon determining that the subscription is to be converted for the customer, processing may proceed to block 894. Upon determining that the subscription is not to be converted for the customer, processing may proceed to block 896.

At block 894, the subscription (e.g., the subscription assigned to the customer at block 888) may be converted for the customer. At block 898, the process depicted by flowchart 880 ends.

In at least one embodiment, a subscription may be converted for the customer by changing a type of subscription assigned to the customer for accessing the service previously provided by the subscription. For example, when the subscription is a RAS subscription having a term of service (e.g., a trial period), the type of subscription for the service may be converted to a different type of subscription (e.g., a regular subscription) having a term of service that is different from the subscription assigned at block 888. By converting the subscription to a different type of subscription, the customer can access the service for a different a term that is longer or shorter depending to the need for the service. In one example, when a subscription is a RAS subscription defined by a trial period, a customer may wish to convert the RAS subscription to a regular subscription (e.g., a production subscription). The regular subscription may enable the customer to implement a production environment.

As explained above, the subscription may be converted by a conversion process. If input is provided by the customer, a subscription may be converted using the criteria provided by the customer. For example, a type of subscription may be chosen based on the input from the customer. In some embodiments, the type of subscription may be chosen based on information determined by the service infrastructure system.

Upon completion of the conversion process, the subscription assigned from the service pool is removed from the service pool. By removing the subscription from the service pool, the subscription may no longer be assigned to another customer.

Now returning back to block 892, upon determining that the subscription is not to be converted for the customer, then at block 896, the subscription (e.g., the subscription assigned to the customer at block 888) may be returned to the service pool. The subscription may be returned to the service pool by assigning the subscription from the customer to the service pool. For example, the subscription assigned to the customer at block 888, may be assigned back to the service pool, therefore, returning the subscription back the service pool. For example, RAS3 816 in FIG. 8A may be assigned 826 from customer 1 to service pool 810 as RAS3 816. Once a subscription is returned back to a service pool, the subscription may be reassigned to one or more additional customers (e.g., the same customer or another customer).

Returning a subscription to the service pool may include removing an association between the customer-specific data and the service-specific data corresponding to the service accessible by the subscription. In one illustrative example, if a customer decides not to purchase the service provided by the assigned subscription, the customer-specific data is removed from the subscription before the subscription is assigned to the service pool. By removing the customer-specific data from the subscription before it is assigned to the service pool, the subscription may be reassigned, and therefore, reusable by other customers. In some embodiments, the customer-specific data may be stored in association with a customer identity. By storing the customer-specific data in association with the customer identity, the customer-specific data may be easily removed before returning the RAS to the service pool.

Returning a subscription to the service pool may include implementing a deallocation process. The deallocation process may be performed based on the type of service provided by the subscription. In one example, deallocation process for a service provided that is a database-as-a-service (DBAAS) may include deleting one or more users created by the customer for the service provided by the subscription assigned at block 888. In another example, the deallocation process for a service that is an object storage service may include deleting the storage objects created by the customer where the subscription is a RAS subscription. In some embodiments, the deallocation process may include reinitializing resource usage statistics of the subscription (e.g., a RAS subscription) to allow another customer that is assigned the subscription to use a quota of resources provided for that subscription.

At block 898, the process depicted by flowchart 880 ends.

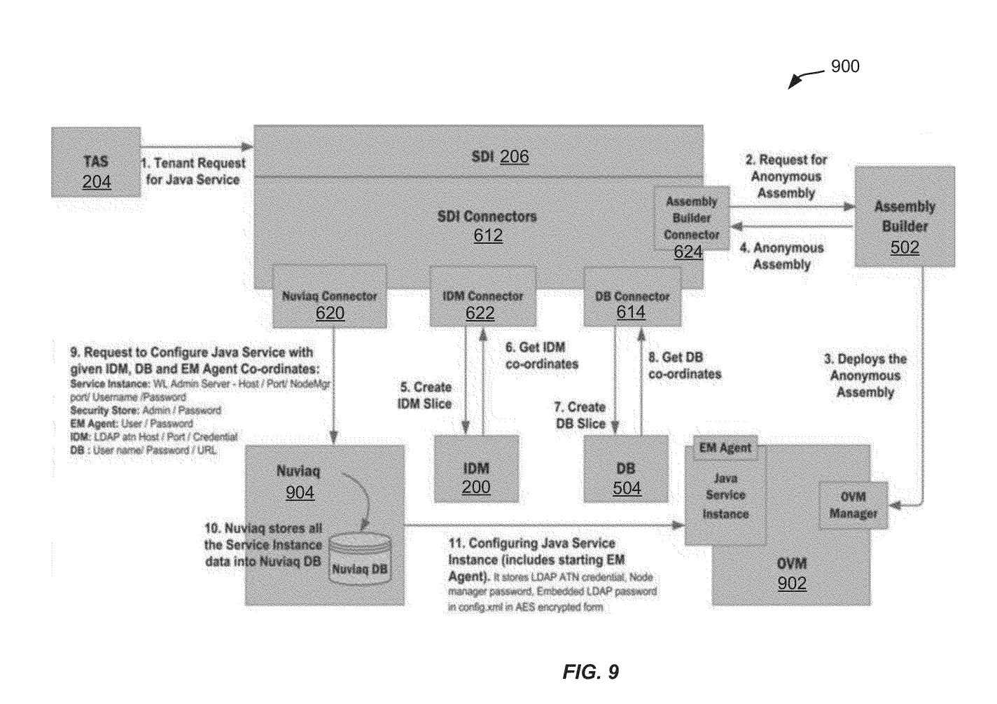

FIG. 9 illustrates a high level overview of the various interactions involved to provide a tenant environment, in accordance with an embodiment of the present invention.

At (1), a tenant request for Java service is sent from TAS 204 to SDI 206. SDI 260 provisioned the requested Java service from a pool of reusable anonymous subscriptions. SDI 206 includes SDI connectors 612. SDI connectors 612 include Nuviaq connector 620, IDM connector 622, DB connector 614, and assembly builder 624.

Prior to receiving the tenant request, as discussed above, SDI 206 provisions one or more pools of one or more reusable anonymous subscriptions. For example, when SDI 206 requires the provisioning of a new Java subscription, at (2), a request for anonymous assembly is sent from assembly builder connector 624 of SDI connectors 612 to assembly builder 502. At (3), an anonymous assembly is deployed by assembly builder 502, through virtual machine OVM 902. At (4), assembly builder 502 returns a result of the anonymous assembly to assembly builder connector 624.

At (5), a command to create an IDM slice is sent from IDM connector 622 to IDM 200. At (6), IDM coordinates are sent back from IDM 200 to IDM connector 622. At (7), DB connector 614 commands the creation of a DB slice through DB 504. At (8), DB coordinates are sent back from DB 504 to DB connector 614.

At (9), a request to configure the Java service with the given IDM, DB, and EM agent (if applicable) coordinates is sent from Nuviaq connector 620 to Nuviaq database application 904. At (10), Nuviaq database application 904 stores all the service instance data. At (11), the Java service instance is configured, including starting the EM agent. A lightweight directory access protocol (LDAP) ATN credential, node manager password, and embedded LDAP password are stored in a config.xml file in advanced encryption standard (AES) encrypted form, available to OVM 902. Other services besides a Java service can be created using the SDI module, including services of different types.

Multiple services can be provided in a computer network cloud infrastructure system. Such services can include simple, infrastructure as a service (IAAS) services, platform as a service (PAAS) services, and software as a service (SAAS) services. The IAAS, PAAS, and SAAS services are different types of services from one another.

IAAS services can include simple storage solutions. Storage solutions can include a remote set of disk drives or other memory devices that are accessible from the Internet. They can also include File Transfer Protocol (FTP), virtual private network (VPN), or other services for uploading, downloading, and tracking data saved on the disk drives. IAAS storage solutions can include functions beyond mere storage, such as redundancy and backup services. IAAS services can also include processing power, bandwidth to other parts of the globe, and other computer resources.

PAAS services can include database cloud services, middleware cloud services, Java cloud services, and other services typically offered as a software platform. Database services can include access to a relational database engine, such as an SQL database engine. Tables and other database schema can be designed and implemented on the cloud by a user, and the database management engine is used by the user to input and export data from the database. Likewise, Java or other programming languages can be used to create custom applications on the cloud system by a user and then executed on the cloud system. Other middleware applications, supporting custom user interfaces and data structures, can be designed and executed by users who are remote from the cloud servers.

SAAS services can include customer relationship management (CRM) services. These can help salesmen track leads, support personnel maintain customer accounts, and customers themselves view data about their own accounts. Human capital management (HCM) and talent services can help employers store information about employees and independent contractors. Labor hour tracking, asset checkout, and payroll tracking and payment can be provided by such services.

Provisioning of cloud resources for a service can occur asynchronously. For example, a method or function can be called through an application programming interface (API) with argument variables that include a call back address. Rather than a calling method of a module waiting for a called method to end before carrying on, the called method can send a message to the module when it is complete. The called method can also send status updates to the module. Because provisioning for some services, such as SAAS services, may take hours or days and provisioning for other services, such as IAAS services, may take a few minutes, this asynchronous API calling can be useful in ensuring that the shortest-startup-time services are provisioned earlier rather than later, even when they are provisioned with other longer-startup-time services.

### CONCLUSION

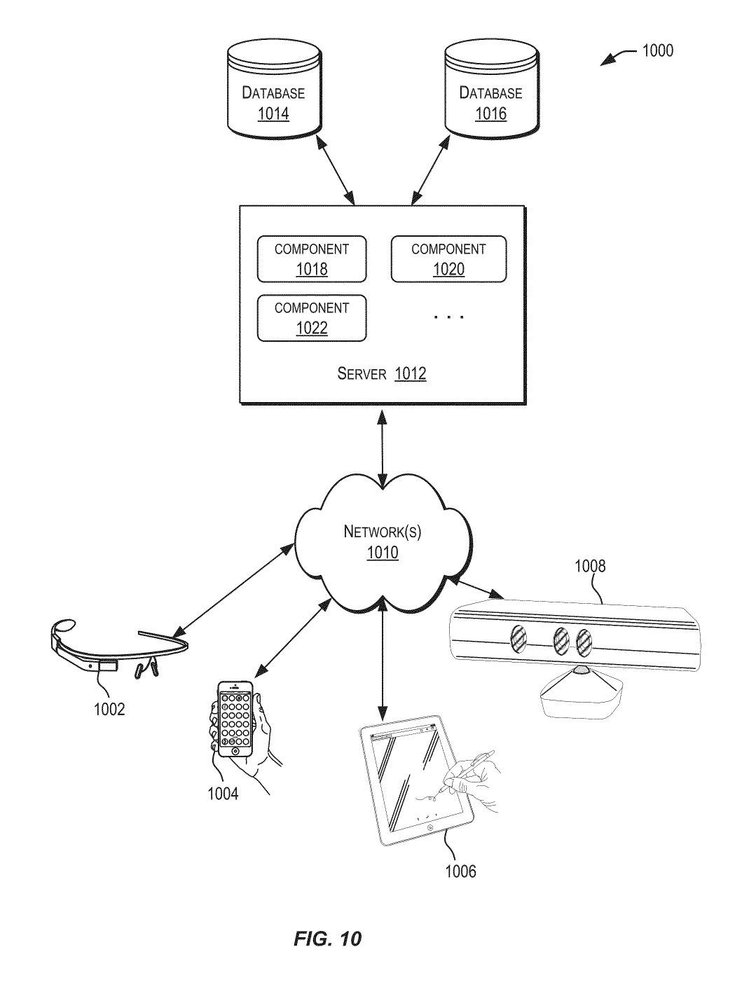

FIG. 10 depicts a simplified diagram of a distributed system 1000 for implementing an embodiment. In the illustrated embodiment, distributed system 1000 includes one or more client computing devices 1002, 1004, 1006, and 1008, which are configured to execute and operate a client application such as a web browser, proprietary client (e.g., Oracle Forms), or the like over one or more network(s) 1010. Server 1012 may be communicatively coupled with remote client computing devices 1002, 1004, 1006, and 1008 via network 1010.

In various embodiments, server 1012 may be adapted to run one or more services or software applications such as services and applications for providing a user with access to a service that has already been provisioned by a cloud infrastructure system. In certain embodiments, server 1012 may also provide other services or software applications can include non-virtual and virtual environments. In some embodiments, these services may be offered as web-based or cloud services or under a Software as a Service (SaaS) model to the users of client computing devices 1002, 1004, 1006, and/or 1008. Users operating client computing devices 1002, 1004, 1006, and/or 1008 may in turn utilize one or more client applications to interact with server 1012 to utilize the services provided by these components.

In the configuration depicted in FIG. 10, software components 1018, 1020 and 1022 of system 1000 are shown as being implemented on server 1012. In other embodiments, one or more of the components of system 1000 and/or the services provided by these components may also be implemented by one or more of the client computing devices 1002, 1004, 1006, and/or 1008. Users operating the client computing devices may then utilize one or more client applications to use the services provided by these components. These components may be implemented in hardware, firmware, software, or combinations thereof. It should be appreciated that various different system configurations are possible, which may be different from distributed system 1000. The embodiment shown in FIG. 10 is thus one example of a distributed system for implementing an embodiment system and is not intended to be limiting.

Client computing devices 1002, 1004, 1006, and/or 1008 may include various types of computing systems. For example, client device may include portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like. The devices may support various applications such as various Internet-related apps, e-mail, short message service (SMS) applications, and may use various other communication protocols. The client computing devices may also include general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Client computing devices may also include electronic devices such as a thin-client computer, an Internet-enabled gaming system (e.g., a Microsoft Xbox gaming console with or without a Kinect® gesture input device), and/or a personal messaging device, capable of communicating over network(s) 1010.

Although distributed system 1000 in FIG. 10 is shown with four client computing devices, any number of client computing devices may be supported. Other devices, such as devices with sensors, etc., may interact with server 1012.

Network(s) 1010 in distributed system 1000 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk, and the like. Merely by way of example, network(s) 1010 can be a local area network (LAN), networks based on Ethernet, Token-Ring, a wide-area network, the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol), and/or any combination of these and/or other networks.

Server 1012 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 1012 can include one or more virtual machines running virtual operating systems, or other computing architectures involving virtualization. One or more flexible pools of logical storage devices can be virtualized to maintain virtual storage devices for the server. Virtual networks can be controlled by server 1012 using software defined networking. In various embodiments, server 1012 may be adapted to run one or more services or software applications described in the foregoing disclosure. For example, server 1012 may correspond to a server for performing processing as described above according to an embodiment of the present disclosure.

Server 1012 may run an operating system including any of those discussed above, as well as any commercially available server operating system. Server 1012 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 1012 may include one or more applications to analyze and consolidate data feeds and/or event updates received from users of client computing devices 1002, 1004, 1006, and 1008. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1012 may also include one or more applications to display the data feeds and/or real-time events via one or more display devices of client computing devices 1002, 1004, 1006, and 1008.

Distributed system 1000 may also include one or more databases 1014 and 1016. These databases may provide a mechanism for storing information such as user interactions information, usage patterns information, adaptation rules information, and other information used by embodiments of the present invention. Databases 1014 and 1016 may reside in a variety of locations. By way of example, one or more of databases 1014 and 1016 may reside on a non-transitory storage medium local to (and/or resident in) server 1012. Alternatively, databases 1014 and 1016 may be remote from server 1012 and in communication with server 1012 via a network-based or dedicated connection. In one set of embodiments, databases 1014 and 1016 may reside in a storage-area network (SAN). Similarly, any necessary files for performing the functions attributed to server 1012 may be stored locally on server 1012 and/or remotely, as appropriate. In one set of embodiments, databases 1014 and 1016 may include relational databases, such as databases provided by Oracle, that are adapted to store, update, and retrieve data in response to SQL-formatted commands.

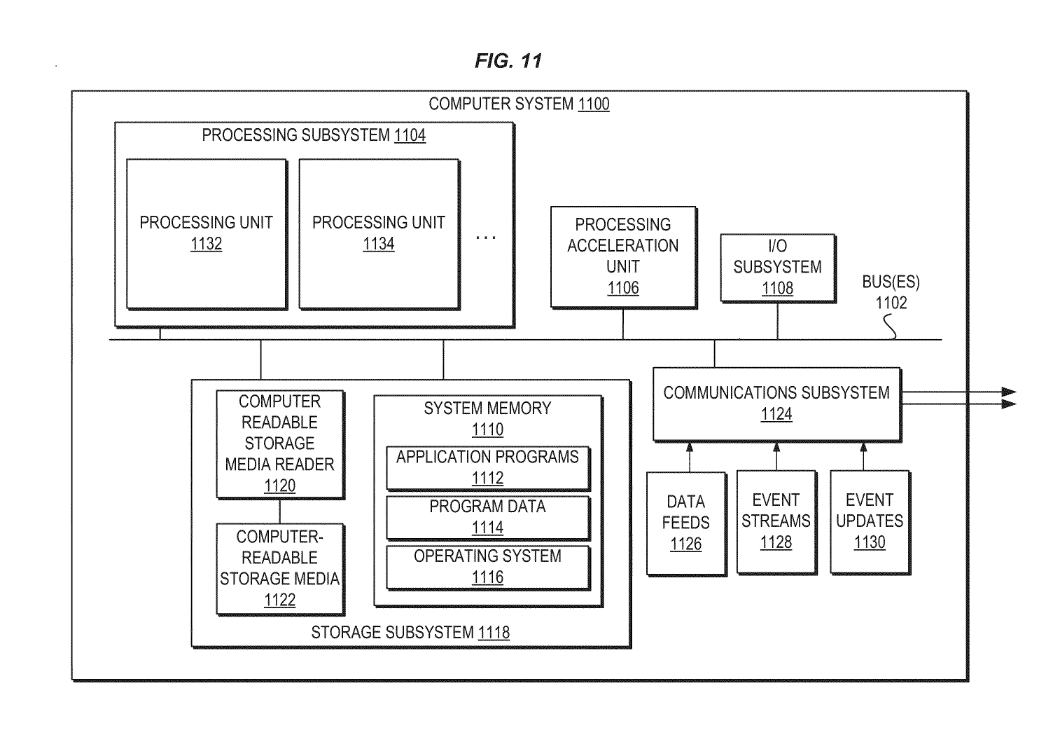

FIG. 11 illustrates an exemplary computer system 1100 that may be used to implement an embodiment of the present invention. In some embodiments, computer system 1100 may be used to implement any of the various servers and computer systems described above. As shown in FIG. 11, computer system 1100 includes various subsystems including a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 may include tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1104 controls the operation of computer system 1100 and may comprise one or more processing units 1132, 1134, etc. A processing unit may include be one or more processors, including single core or multicore processors, one or more cores of processors, or combinations thereof. In some embodiments, processing subsystem 1104 can include one or more special purpose co-processors such as graphics processors, digital signal processors (DSPs), or the like. In some embodiments, some or all of the processing units of processing subsystem 1104 can be implemented using customized circuits, such as application specific integrated circuits (ASICs), or field programmable gate arrays (FPGAs).

In some embodiments, the processing units in processing subsystem 1104 can execute instructions stored in system memory 1110 or on computer readable storage media 1122. In various embodiments, the processing units can execute a variety of programs or code instructions and can maintain multiple concurrently executing programs or processes. At any given time, some or all of the program code to be executed can be resident in system memory 1110 and/or on computer-readable storage media 1122 including potentially on one or more storage devices. Through suitable programming, processing subsystem 1104 can provide various functionalities described above for providing a user with access to a service that has already been provisioned by a cloud infrastructure system

In certain embodiments, a processing acceleration unit 1106 may be provided for performing customized processing or for off-loading some of the processing performed by processing subsystem 1104 so as to accelerate the overall processing performed by computer system 1100.

I/O subsystem 1108 may include devices and mechanisms for inputting information to computer system 1100 and/or for outputting information from or via computer system 1100. In general, use of the term “input device” is intended to include all possible types of devices and mechanisms for inputting information to computer system 1100. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 1118 provides a repository or data store for storing information that is used by computer system 1100. Storage subsystem 1118 provides a tangible non-transitory computer-readable storage medium for storing the basic programming and data constructs that provide the functionality of some embodiments. Software (programs, code modules, instructions) that when executed by processing subsystem 1104 provide the functionality described above may be stored in storage subsystem 1118. The software may be executed by one or more processing units of processing subsystem 1104. Storage subsystem 1118 may also provide a repository for storing data used in accordance with the present invention.

Storage subsystem 1118 may include one or more non-transitory memory devices, including volatile and non-volatile memory devices. As shown in FIG. 11, storage subsystem 1118 includes a system memory 1110 and a computer-readable storage media 1122. System memory 1110 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1100, such as during start-up, may typically be stored in the ROM. The RAM typically contains data and/or program modules that are presently being operated and executed by processing subsystem 1104. In some implementations, system memory 1110 may include multiple different types of memory, such as static random access memory (SRAM) or dynamic random access memory (DRAM).

By way of example, and not limitation, as depicted in FIG. 11, system memory 1110 may store application programs 1112, which may include client applications, Web browsers, mid-tier applications, relational database management systems (RDBMS), etc., program data 1114, and an operating system 1116. By way of example, operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Computer-readable storage media 1122 may store programming and data constructs that provide the functionality of some embodiments. Software (programs, code modules, instructions) that when executed by processing subsystem 1104 a processor provide the functionality described above may be stored in storage subsystem 1118. By way of example, computer-readable storage media 1122 may include non-volatile memory such as a hard disk drive, a magnetic disk drive, an optical disk drive such as a CD ROM, DVD, a Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. Computer-readable media 1122 may provide storage of computer-readable instructions, data structures, program modules, and other data for computer system 1100.

In certain embodiments, storage subsystem 1100 may also include a computer-readable storage media reader 1120 that can further be connected to computer-readable storage media 1122. Together and, optionally, in combination with system memory 1110, computer-readable storage media 1122 may comprehensively represent remote, local, fixed, and/or removable storage devices plus storage media for storing computer-readable information.

In certain embodiments, computer system 1100 may provide support for executing one or more virtual machines. Computer system 1100 may execute a program such as a hypervisor for facilitating the configuring and managing of the virtual machines. Each virtual machine may be allocated memory, compute (e.g., processors, cores), I/O, and networking resources. Each virtual machine typically runs its own operating system, which may be the same as or different from the operating systems executed by other virtual machines executed by computer system 1100. Accordingly, multiple operating systems may potentially be run concurrently by computer system 1100. Each virtual machine generally runs independently of the other virtual machines.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to establish a communication channel to one or more client devices via the Internet for receiving and sending information from and to the client devices.

Communication subsystem 1124 may support both wired and/or wireless communication protocols. For example, in certain embodiments, communications subsystem 1124 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1124 can provide wired network connectivity (e.g., Ethernet) in addition to or instead of a wireless interface.

Communication subsystem 1124 can receive and transmit data in various forms. For example, in some embodiments, communications subsystem 1124 may receive input communication in the form of structured and/or unstructured data feeds 1126, event streams 1128, event updates 1130, and the like. For example, communications subsystem 1124 may be configured to receive (or send) data feeds 1126 in real-time from users of social media networks and/or other communication services such as Twitter® feeds, Facebook® updates, web feeds such as Rich Site Summary (RSS) feeds, and/or real-time updates from one or more third party information sources.

In certain embodiments, communications subsystem 1124 may be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system.

Due to the ever-changing nature of computers and networks, the description of computer system 1100 depicted in FIG. 11 is intended only as a specific example. Many other configurations having more or fewer components than the system depicted in FIG. 11 are possible. Based on the disclosure and teachings provided herein, a person of ordinary skill in the art will appreciate other ways and/or methods to implement the various embodiments.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps. Various features and aspects of the above-described embodiments may be used individually or jointly.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for interprocess communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific invention embodiments have been described, these are not intended to be limiting. Various modifications and equivalents are within the scope of the following claims.

That which is claimed is:

1. A method comprising:
providing multiple services in a service infrastructure system, wherein each service of the services is associated with service-specific data;
receiving, by the service infrastructure system, a request by a first customer to access a first service in the multiple services;
determining, by the service infrastructure system, that the first service has been provisioned for a first subscription in a service pool by the service infrastructure system;
assigning, by the service infrastructure system, the first subscription for the first service from the service pool to the first customer, wherein assigning the first subscription to the first customer includes removing the first subscription from the service pool;
associating, by the service infrastructure system, customer-specific data corresponding to the first customer with service-specific data corresponding to the first service, wherein the customer-specific data is associated with the first customer for the first service; and
assigning, by the service infrastructure system, the first subscription from the first customer to the service pool, wherein assigning the first subscription includes removing an association between the customer-specific data and the service-specific data corresponding to the first service, and wherein the first subscription is reassignable from the service pool to one or more additional customers.

2. The method of claim 1 wherein providing the services includes provisioning one or more of the services in the cloud infrastructure system prior to receiving the request by the first customer, and wherein a service is provisioned based on one or more metrics related to operation of the service infrastructure system.

3. The method of claim 1 wherein providing the services includes provisioning one or more of the services prior to receiving the request by the first customer, and wherein a service is provisioned based on one or more metrics associated with demand for the service.

4. The method of claim 1 wherein providing the services includes provisioning one or more of the services prior to receiving the request by the first customer, and wherein a service is provisioned based on one or more metrics associated with the type of the service.

5. The method of claim 1 wherein the service-specific data corresponding to a service indicates a configuration for the service, and wherein the configuration includes one or more resources allocated to provide the service.

6. The method of claim 1 wherein the customer-specific data associated with the first customer includes data related to use of the first service by the customer.

7. The method of claim 1 further comprising:
receiving a request by a second customer to access a second service in the multiple services;
determining that the second service is available in the service pool based on determining that the second service is similar to the first service;
assigning the first subscription in the service pool to the second customer, wherein assigning the first subscription to the second customer includes removing the first subscription from the service pool; and
associating customer-specific data corresponding to the second customer with service-specific data corresponding to the first service.

8. The method of claim 1 wherein the service infrastructure system includes a multi-tenant environment.

9. The method of claim 1 wherein the services include a Java® service, a customer relationship management (CRM) service, or a human capital management (HCM) service.

10. The method of claim 1 wherein the service pool includes a plurality of subscriptions, and wherein each of the plurality of subscriptions is associated with at least one service provided by the service infrastructure system.

11. The method of claim 1 further comprising:
provisioning the first service for the first subscription in the service pool upon determining that the first service has not been provisioned for a subscription in the service pool.

12. A system comprising:
at least one processor; and
a memory operatively coupled with the at least one processor, the at least one processor executing computer code stored in the memory for:
providing multiple services in a service infrastructure system, wherein each service of the services is associated with service-specific data;
receiving a request by a first customer to access a first service in the multiple services;
determining that the first service has been provisioned for a first subscription in a service pool by the service infrastructure system;
assigning the first subscription for the first service from the service pool to the first customer, wherein assigning the first subscription to the first customer includes removing the first subscription from the service pool;
associating customer-specific data corresponding to the first customer with service-specific data corresponding to the first service, wherein the customer-specific data is associated with the first customer for the first service; and
assigning the first subscription from the first customer to the service pool, wherein assigning the first subscription includes removing an association between the customer-specific data and the service-specific data corresponding to the first service, and wherein the first subscription is reassignable from the service pool to one or more additional customers.

13. The system of claim 12 wherein providing the services includes provisioning one or more of the services in the cloud infrastructure system prior to receiving the request by the first customer.

14. The system of claim 12 wherein the service-specific data corresponding to a service indicates a configuration for the service, and wherein the configuration includes one or more resources allocated to provide the service.

15. The system of claim 12 wherein the customer-specific data associated with the first customer includes data related to use of the first service by the customer.

16. The system of claim 12 wherein the at least one processor further executes computer code stored in the memory for:
receiving a request by a second customer to access a second service in the multiple services;
determining that the second service is available in the service pool based on determining that the second service is similar to the first service;
assigning the first subscription in the service pool to the second customer, wherein assigning the first subscription to the second customer includes removing the first subscription from the service pool; and
associating customer-specific data corresponding to the second customer with service-specific data corresponding to the first service.

17. A non-transitory computer-readable medium storing instructions executable by a processor of a computer system for:
providing multiple services in a service infrastructure system, wherein each service of the services is associated with service-specific data;
receiving, by the service infrastructure system, a request by a first customer to access a first service in the multiple services;
determining, by the service infrastructure system, that the first service has been provisioned for a first subscription in a service pool by the service infrastructure system;
assigning, by the service infrastructure system, the first subscription for the first service from the service pool to the first customer, wherein assigning the first subscription to the first customer includes removing the first subscription from the service pool;
associating, by the service infrastructure system, customer-specific data corresponding to the first customer with service-specific data corresponding to the first service, wherein the customer-specific data is associated with the first customer for the first service; and
assigning, by the service infrastructure system, the first subscription from the first customer to the service pool, wherein assigning the first subscription includes removing an association between the customer-specific data and the service-specific data corresponding to the first service, and wherein the first subscription is reassignable from the service pool to one or more additional customers.

18. The non-transitory computer-readable medium of claim 17 wherein providing the services includes provisioning one or more of the services prior to receiving the request by the first customer.

19. The non-transitory computer-readable medium of claim 17 wherein the customer-specific data associated with the first customer includes data related to use of the first service by the customer.

20. The non-transitory computer-readable medium of claim 17 wherein the service pool includes a plurality of subscriptions, and wherein each of the plurality of subscriptions is associated with at least one service provided by the service infrastructure system.
